(19) United States
(12) Patent Application Publication
(10) Pub. No.: US 2004/0078184 A1
(43) Pub. Date: Apr. 22, 2004

(54) Logic emulator

(76) Inventors: Tomoyuki Inomoto, Iizuka (JP); Kenichi Ishida, Kasuya-Gun (JP); Tomoo Kimura, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/385,508

(22) Filed: Mar. 12, 2003

(30) Foreign Application Priority Data
Mar. 13, 2002 (JP) 2002-068714

(51) Int. Cl. G06F 9/455

(52) U.S. Cl. 703/23

(57) ABSTRACT

Each of terminals of a terminal group of a variable wiring element is connected to each three corresponding signal lines between three variable logic elements. The signal lines connected to the terminals of the terminal group of the variable wiring element can be used by any of the variable logic elements. Thus, depending on the number of signal lines used by each of the variable logic elements determined by the result of dividing of an under-verification circuit, the signal lines are selectively used. This allows efficient use of the signal lines.

### BACKGROUND OF THE INVENTION

1. Field of the Invention

The present invention relates to a logic emulator for verifying a large-scale integrated circuit.

2. Description of the Related Art

Recently, a logic emulator is used as a device for verifying an operation of a large-scale integrated circuit (under-verification circuit) in the development of large-scale integrated circuits (LSI).

The logic emulator is generally such that it divides an under-verification circuit, assigns the divided circuits to a plurality of variable logic elements, and is able to verify them at a high speed by actually operating them.

Logic emulators, from the characteristics of the devices, usually have the function of observing a signal (verified internal signal) selected arbitrarily by a user within a circuit (under-verification sub-circuit) which has been divided from an under-verification circuit and then assigned to a variable logic element for the purpose of the debug of the under-verification circuit. This aspect is described below more specifically with reference to the drawings.

FIG. 18 is a block diagram of a prior art logic emulator. As shown in FIG. 18, the prior art logic emulator comprises variable logic elements 202 through 204, a variable wiring element 205, a trace controlling circuit 206, a trace memory 207, a host interface circuit 208, and a host workstation 209.

This prior art logic emulator 201 is used in a state of being connected to an external device 200.

The relation of connection is described below.

The variable logic element 202 and the external device 200 are connected by a wiring 210. The variable logic element 203 and the external device 200 are connected by a wiring 211. Each of the wirings 210 and 211 comprises a plurality of signal lines.

The variable logic element 202 and the variable wiring element 205 are connected by a wiring 212. The variable logic element 203 and the variable wiring element 205 are connected by a wiring 213. The variable logic element 204 and the variable wiring element 205 are connected by a wiring 214.

More specific description is as follows. Each of the wirings 212 through 214 comprises a plurality of signal lines. Each of the variable logic elements 202 through 204 comprises a plurality of terminals (not illustrated). The variable wiring element 205 comprises a plurality of terminals (not illustrated).

Then, each terminal of the variable logic elements 202 through 204 and each terminal of the variable wiring element 205 have one-to-one correspondence to each other, and thereby are connected by each signal line of the wirings 212 through 214.

The variable wiring element 205 and the trace controlling circuit 206 are connected by a wiring 215. The variable wiring element 205 and the trace memory 207 are connected by a wiring 216.

The trace controlling circuit 206 and the trace memory 207 are connected by a wiring 217. The trace controlling circuit 206 and the host interface circuit 208 are connected by a wiring 220.

The trace memory 207 and the host interface circuit 208 are connected by a wiring 218. The host interface circuit 208 and the host workstation 209 are connected by a wiring 219.

The function and operation of each component are described below.

An example of the external device 200 is described below. Various circuits and components such as LSIs, which are actually used in combination with an under-verification circuit divided and assigned to respective variable logic elements 202 through 204 of the logic emulator 201, are mounted in the external device 200.

The external device 200 is able to verify an under-verification circuit in a state very close to an actual use state thereof by connecting the logic emulator 201 thereto.

A description is given of another example of the external device 200. The external device 200 gives a verification test pattern to inputs of the under-verification sub-circuits 230 through 232 assigned to the respective variable logic elements 202 through 204 of the logic emulator 201.

The external device 200 observes outputs of the under-verification sub-circuits 230 through 232.

The variable logic elements 202 through 204 of the logic emulator 201 are elements, the logic emulated in the inside of which can be altered from the outside, and which thereby emulate a function based on the logic having been set.

The variable wiring element 205 is an element which implements the connection between the variable logic elements 202 through 204, and the connection implemented in the inside of which can be altered from the outside.

The trace memory 207 stores information indicated by the verified internal signals of the under-verification sub-circuits assigned to the variable logic elements 202 through 204, at predetermined time intervals.

At that time, the verified internal signals of the under-verification sub-circuits assigned to the variable logic elements 202 through 204 are provided through the wirings 212 through 214, the variable wiring element 205, and the wiring 216, to the trace memory 207.

The trace controlling circuit 206 acquires the verified internal signals of the under-verification sub-circuits assigned to the variable logic elements 202 through 204 through the wirings 212 through 214, the variable wiring element 205, and the wiring 215, and thereby uses the signals for control of the trace memory 207.

More specifically, the trace controlling circuit 206 monitors the verified internal signals of the under-verification sub-circuits assigned to the variable logic elements 202 through 204, and thereby instructs the start or the stop of writing of data into the trace memory 207 in a case that the information indicated by the verified internal signal agrees with a condition set by the host workstation 209.

Through the host interface circuit 208, the host workstation 209 acquires the verified internal signals of the under-verification sub-circuits assigned to the variable logic elements 202 through 204 stored in the trace memory 207, and thereby analyzes the operation of the under-verification circuit which has been divided and assigned to the variable logic elements 202 through 204.

Described below are problems in the prior art logic emulator 201 described above. Problems associated mainly with the variable wiring element 205 are described first.

In the prior art logic emulator 201, the variable wiring element 205 has merely a finite number of terminals.

This places a limit on the number of signal lines between the variable logic elements 202 through 204 and the variable wiring element 205.

Even in a case that a greater number of variable wiring elements are used, such limitation still exists.

Further, the use of a greater number of variable wiring elements causes a problem of higher cost of the logic emulator.

From the perspective of these points, specific examples of the problems associated mainly with the variable wiring element 205 are described below with reference to FIG. 18.

Assumed here is that N terminals are available for connection between each of the variable logic elements 202 through 204 and the variable wiring element 205.

In this case, in the design step, the number of signal lines of each of the wirings 212 through 214 is set to be M such that the total number of signal lines of the wirings 212 through 214 is N. For example, in the design step, the number is set such that M=N/3.

Meanwhile, when an under-verification circuit is divided and assigned to the variable logic elements 202 through 204, such a situation can occur that depending on the result of the dividing of the under-verification circuit, the number of necessary signal lines varies for each of the variable logic elements 202 through 204 and the variable wiring element 205.

For example, when each of the wirings 212 through 214 has M (=N/3) signal lines, there can be such a case that the signals to be transmitted between the variable logic element 202 and the variable wiring element 205 require L signal lines which are more than the M signal lines present in the wiring 212, whereas the signals to be transmitted between the variable logic element 203 and the variable wiring element 205 require only R signal lines which are less than the M signal lines present in the wiring 213

In this case, the signals requiring L signal lines which are more than the M signal lines present in the wiring 212 need to be transmitted by time division multiplex.

This causes a problem of an increase in the delay in signal transmission between the variable logic elements 202 through 204. On the other hand, in the wiring 213, the excess of (M?R) signal lines causes a problem of wastefulness in the signal lines.

In order that such wastefulness is avoided in the signal lines, the under-verification circuit could be divided such that the number of signal lines necessary for connection between the under-verification sub-circuits 230 through 232 assigned to the variable logic elements 202 through 204 agrees with the number of signal lines between each of the variable logic elements 202 through 204 and the variable wiring element 205. Nevertheless, this causes an increase in restricting conditions.

This causes a problem of an increase in the process time of the program for dividing the under-verification circuit. Further, in this case, the rate of use of the internal circuit varies depending on the variable logic elements 202 through 204. This causes a problem of wastefulness in the rate of use of internal circuits among the variable logic elements 202 through 204.

Those described above are problems associated mainly with the variable wiring element 205.

Described below are problems associated mainly with the variable logic elements 202 through 204.

In the prior art logic emulator 201 shown in FIG. 18, the signal lines between the variable logic elements 202 through 204 and the variable wiring element 205 are consumed when the verified internal signals of the under-verification sub-circuits are transmitted from the variable logic elements 202 through 204 to the trace controlling circuit 206.

This causes a problem of deficiency in the signal lines used for connection between the under-verification sub-circuits 230 through 232 assigned to the variable logic elements 202 through 204.

Further, in each of the variable logic elements 202 through 204, the signals between the under-verification sub-circuits 230 through 232 assigned to the variable logic elements 202 through 204, the verified internal signals stored in the trace memory 207, and the verified internal signals provided to the trace controlling circuit 206 are all outputted or inputted through the terminals of the variable logic elements 202 through 204.

This causes a problem of deficiency in the input and output terminals of the variable logic elements 202 through 204.

Those described above are problems associated mainly with the variable logic elements 202 through 204.

### OBJECTS AND SUMMARY OF THE INVENTION

An object of the invention is to provide a logic emulator which causes neither an increase in the process time for dividing an under-verification circuit nor wastefulness in the internal circuits of variable logic elements, and which thereby uses signal lines efficiently.

Another object of the invention is to provide a logic emulator which resolves, as much as possible, deficiency in signal lines and in terminals of variable logic elements used in signal transmission between the variable logic elements.

A logic emulator according to a first aspect of the invention comprises: a plurality of variable logic units to which an under-verification circuit is divided and assigned, and the logic emulated inside each of which can be altered from the outside; and a variable wiring unit for connecting a plurality of variable logic units according to the information of a circuit to which the under-verification circuit is divided and assigned; wherein the variable wiring unit comprises: a plurality of first terminal groups which are provided correspondingly to a plurality of variable logic units, and each of which comprises a plurality of terminals; and a second terminal group which is provided correspondingly to a predetermined plurality of variable logic units, and which comprises a plurality of terminals; and wherein: each of the terminals of each of the first terminal groups is connected to a corresponding signal line wired to a corresponding variable logic unit; and each of the terminals of the second terminal group is connected to a plurality of corresponding signal lines between the predetermined plurality of variable logic units.

According to this configuration, the signal lines connected to the terminals of the second terminal group can be used by any of the predetermined plurality of variable logic units. That is, the number of signal lines available for variable logic units is variable.

Thus, depending on the number of signal lines used by each variable logic unit determined by the result of dividing of the under-verification circuit, the signal lines are selectively used. Thus, without an increase in the variable wiring units, wastefulness and deficiency in the signal lines for each variable logic unit are suppressed as much as possible. This allows efficient use of the signal lines.

As a result, suppressed as much as possible are: a cost increase caused by the increase in the variable wiring units; a delay in signal transmission between the variable logic units caused by excessive time division multiplex necessary due to the deficiency in the signal lines; and a decrease in operation speed of the circuit (under-verification sub-circuit) assigned to each of the variable logic units, caused by the above-mentioned delay in signal transmission.

Further, avoided is a complicated process of dividing the under-verification circuit in such a manner that the number of signal lines necessary for connection between each of the under-verification sub-circuits assigned to each of the variable logic units agrees with the number of signal lines between the variable logic units and the variable wiring unit.

As a result, suppressed as much as possible are: an increase in the process time for dividing the under-verification circuit; and wastefulness caused by the occurrence of variation in the rate of use of internal circuits among the variable logic units.

A logic emulator according to a second aspect of the invention further comprises a plurality of switching units which are connected correspondingly to the plurality of terminals of the second terminal group, and each of which is connected to a corresponding terminal of the second terminal group, wherein each of the switching units selects a signal line from the plurality of corresponding signal lines between the predetermined plurality of the variable logic units, and then connects the signal line to a corresponding terminal of the second terminal group.

According to this configuration, signal lines coming from the variable logic units and not selected by the switching unit are disconnected from the terminals of the second terminal group of the variable wiring unit.

As a result, suppressed are: signal disturbance caused by the connection of excessive signal lines; and an increase in the power consumption of the device caused by the stray capacitance of the excessive signal lines.

A logic emulator according to a third aspect of the invention comprises: a plurality of variable logic units to which an under-verification circuit is divided and assigned, and the logic emulated inside each of which can be altered; and a plurality of memories which are provided correspondingly to the plurality of variable logic units, and each of which stores information indicated by an internal signal of a circuit in which the under-verification circuit is divided and assigned to a corresponding variable logic unit; wherein each of the variable logic units comprises: a store instructing unit for instructing the storing of the information indicated by the internal signal into a corresponding memory, on the basis of source information extracted from the circuit to which the under-verification circuit is divided and assigned; and a memory controlling unit for controlling the storing of the information indicated by the internal signal into a corresponding memory, accordingly to the instruction by the store instructing unit.

According to this configuration, a store instructing unit for instructing the storing of the information indicated by the internal signal of an under-verification sub-circuit into a corresponding memory, on the basis of source information extracted from the circuit (under-verification sub-circuit) assigned to the variable logic units.

This allows the control of the storing of the information indicated by the internal signal of an under-verification sub-circuit, without the necessity that the source information serving as the basis of the instruction of the storing of the information indicated by the internal signal of the under-verification sub-circuit is outputted to the outside of the variable logic units or alternatively that the instruction for the storing is inputted from the outside.

Thus, the logic emulator does not consume signal lines for the source information and the instruction of the storing at the outside of the variable logic units, while the variable logic unit does not consume terminals for the output of the source information and the input of the instruction of the storing.

This resolves, as much as possible, deficiency in the signal lines and in the terminals of the variable logic units used in the signal transmission between the variable logic units.

A logic emulator according to a fourth aspect of the invention further comprises a condition setting unit capable of arbitrarily setting a condition for storing of the information indicated by the internal signal of the circuit to which the under-verification circuit is divided and assigned, into a corresponding memory, wherein each of the store instructing units instructs storing of the information indicated by the internal signal into a corresponding memory, according to the condition for storing, on the basis of the source information extracted from the circuit to which the under-verification circuit is divided and assigned.

This configuration allows arbitrary setting of a condition for storing, and thereby reduces notably the occurrence of the necessity of compiling of the variable logic units and the writing of circuit data into the variable logic units at each time when the storing condition is changed.

This allows smooth and fast verification of the under-verification circuit.

In a logic emulator according to a fifth aspect of the invention: each of the store instructing units generates a store instruction control signal for controlling the instruction of storing of the information indicated by the internal signal into a corresponding memory, on the basis of the source information extracted from the circuit to which the under-verification circuit is divided and assigned; in response to the store instruction control signal generated by each of the store instructing units, the potential of a common wiring is controlled so that a wired logic is formed; and in response to the potential of the common wiring, each of the memory controlling units controls the storing of information indicated by the internal signal into a corresponding memory.

According to this configuration, a very simple wiring between the variable logic units allows a process that an instruction of storing is generated only when the logic of all the store instruction control signals from all the store instructing units is “true.”

A logic emulator according to a sixth aspect of the invention further comprises a condition setting unit capable of arbitrarily setting a condition for storing of the information indicated by the internal signal of the circuit to which the under-verification circuit is divided and assigned, into a corresponding memory, wherein each of the store instructing units generates a store instruction control signal, according to the condition for storing, on the basis of the source information extracted from the circuit to which the under-verification circuit is divided and assigned.

This configuration allows arbitrary setting of a condition for storing, and thereby reduces notably the occurrence of the necessity of compiling of the variable logic units and the writing of circuit data into the variable logic units at each time when the storing condition is changed.

This allows smooth and fast verification of the under-verification circuit.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a logic emulator according to Embodiment 1 of the invention.

FIG. 2 is a detailed illustration of the logic emulator of FIG. 1.

FIGS. 3 through 5 are views illustrating a first example of the use of the logic emulator of FIG. 1.

FIGS. 6 through 8 are views illustrating a second example of the use of the logic emulator of FIG. 1.

FIG. 9 is a view illustrating a parallel/serial conversion in the logic emulator of FIG. 1.

FIG. 10 is a view illustrating a serial/parallel conversion in the logic emulator of FIG. 1.

FIG. 11 is a block diagram of a logic emulator according to Embodiment 2 of the invention.

FIG. 12 is a view illustrating the detail of the logic emulator of FIG. 2.

FIG. 13 is a block diagram of a logic emulator according to Embodiment 3 of the invention.

FIG. 14 is a block diagram of a logic emulator according to Embodiment 4 of the invention.

FIG. 15 is a block diagram of a trace controlling circuit of the logic emulator of FIG. 14.

FIG. 16 is a block diagram of a logic emulator according to Embodiment 5 of the invention.

FIG. 17 is a block diagram of a trace controlling circuit of the logic emulator of FIG. 16.

FIG. 18 is a block diagram of a prior art logic emulator.

### DETAILED DESCRIPTION OF THE PREFERRED EMBODIMENTS

The embodiments of the invention are described below with reference to the drawings.

(Embodiment 1)

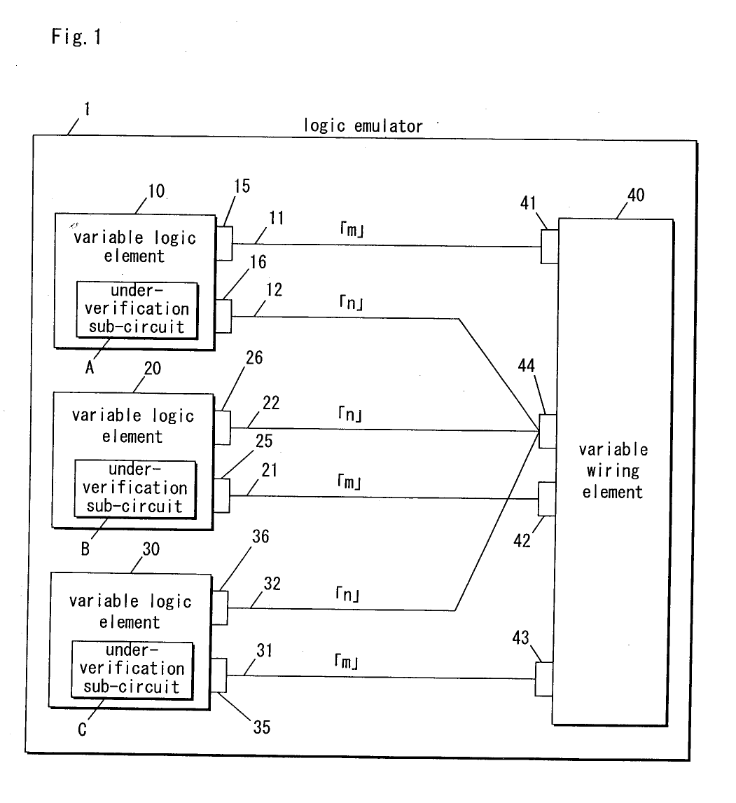

FIG. 1 is a block diagram of a logic emulator according to Embodiment 1 of the invention.

As shown in FIG. 1, the logic emulator 1 comprises variable logic elements 10, 20, and 30 and a variable wiring element 40.

The variable wiring element 40 comprises terminal groups 41 through 44. Each of the terminal groups 41 through 43 comprises m terminals (not illustrated). The terminal group 44 comprises n terminals.

The variable logic element 10 comprises terminal groups 15 and 16. The variable logic element 20 comprises terminal groups 25 and 26. The variable logic element 30 comprises terminal groups 35 and 36.

Each of the terminal groups 15, 25, and 35 comprises m terminals (not illustrated). Each of the terminal groups 16, 26, and 36 comprises n terminals (not illustrated).

A circuit to be verified by the logic emulator 1 (referred to as a “under-verification circuit,” hereinafter in the embodiments) is divided and assigned to each of the variable logic elements 10, 20, and 30.

More specifically, a circuit A obtained by dividing the under-verification circuit (referred to as a “under-verification sub-circuit A,” hereinafter in the embodiments) is assigned to the variable logic element 10. An under-verification sub-circuit B is assigned to the variable logic element 20. An under-verification sub-circuit C is assigned to the variable logic element 30.

An example of such an under-verification circuit is a large-scale integrated circuit. The embodiments are described for the case that the under-verification circuit is an LSI.

Described below are the function and operation of each component.

The variable logic elements 10, 20, and 30 are elements the logic emulated in the inside of which can be altered from the outside, and thereby emulate the function based on the logic having been set.

More specifically, each of the variable logic elements 10, 20, and 30 is a combination of circuits (logic cells) the function of which is programmable, signal lines (program wirings) the wiring arrangement of which is programmable, and a programmable input/output circuit (programmable I/O).

For example, each of the variable logic elements 10, 20, and 30 is composed of an FPGA (Field Programmable Gate Array).

The variable wiring element 40 is an element which implements the connection between the variable logic elements 10, 20, and 30, and the connection implemented in the inside of which can be altered from the outside.

For example, the variable wiring element 40 is composed of an FPID (Field Programmable Interconnect Device).

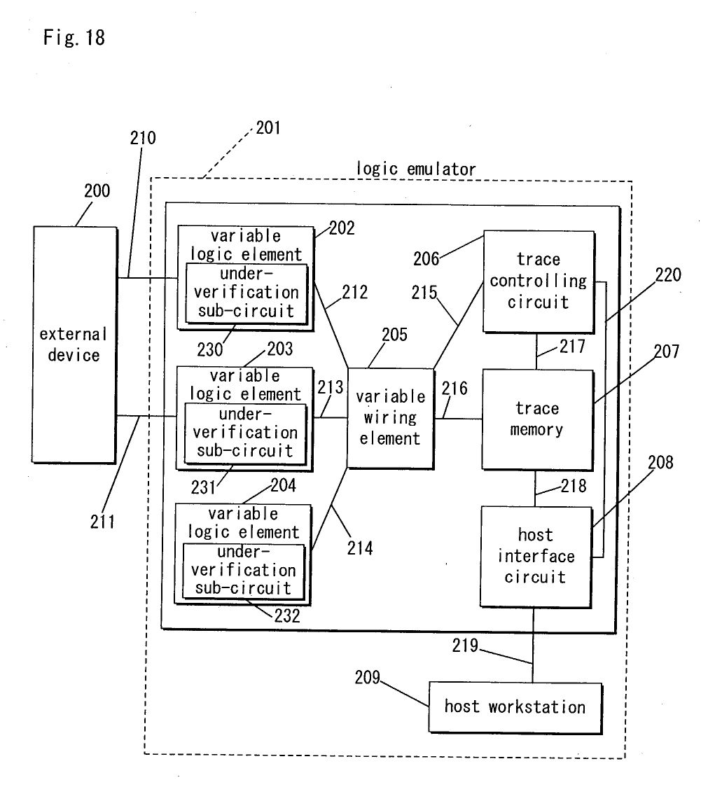

The logic emulator 1 having the above-mentioned configuration is connected to an external device similar to the external device 200 of FIG. 18, and thereby verifies various under-verification circuits.

The wiring connection is described below.

The variable logic elements 10 and the variable wiring element 40 are connected by a wiring 11. The wiring 11 comprises m signal lines.

More specifically, the m terminals of the terminal group 15 of the variable logic element 10 and the m terminals of the terminal group 41 of the variable wiring element 40 are connected by the m signal lines (the wiring 11) in one-to-one correspondence.

The variable logic element 20 and the variable wiring element 40 are connected by a wiring 21. The wiring 21 comprises m signal lines.

More specifically, the In terminals of the terminal group 25 of the variable logic element 20 and the m terminals of the terminal group 42 of the variable wiring element 40 are connected by the m signal lines (the wiring 21) in one-to-one correspondence.

The variable logic element 30 and the variable wiring element 40 are connected by a wiring 31. The wiring 31 comprises m signal lines.

More specifically, the m terminals of the terminal group 35 of the variable logic element 30 and the m terminals of the terminal group 43 of the variable wiring element 40 are connected by the m signal lines (the wiring 31) in one-to-one correspondence.

The variable logic elements 10, 20, and 30 are connected to the variable wiring element 40 by wirings 12, 22, and 32, respectively. Each of the wirings 12, 22, and 32 comprises n signal lines.

More specifically, a terminal of the terminal group 44 of the variable wiring element 40 is connected through a corresponding signal line of the wiring 12 to a corresponding terminal of the terminal group 16 of the variable logic element 10, and connected through a corresponding signal line of the wiring 22 to a corresponding terminal of the terminal group 26 of the variable logic element 20, and further connected through a corresponding signal line of the wiring 32 to a corresponding terminal of the terminal group 36 of the variable logic element 30, in one-to-three correspondence.

As such, each of the n terminals of the terminal group 44 of the variable wiring element 40 is connected to three signal lines each coming from the variable logic elements 10, 20, and 30. This point is described below in detail.

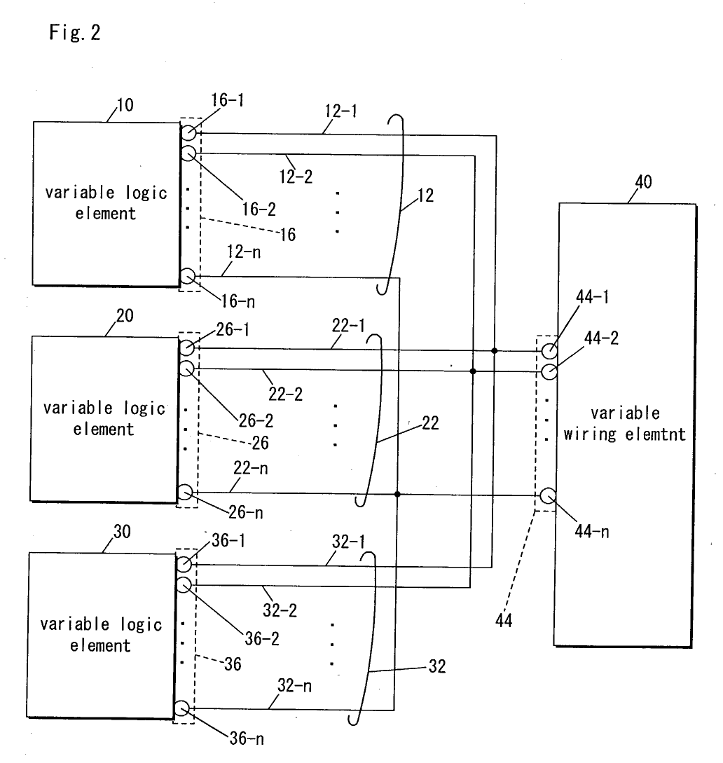

FIG. 2 is a detailed illustration of the wirings of FIG. 1. In FIG. 2, the same parts as in FIG. 1 are designated by the same reference numbers. Further, in FIG. 2, description is omitted for the terminal groups 15, 25, 35, and 41 through 43 of FIG. 1.

As shown in FIG. 2, the terminal group 44 of the variable wiring element 40 comprises n terminals 44-1 through 44-n. The terminal group 16 of the variable logic element 10 comprises n terminals 16-1 through 16-n. The terminal group 26 of the variable logic element 20 comprises n terminals 26-1 through 26-n. The terminal group 36 of the variable logic element 30 comprises n terminals 36-1 through 36-n.

The wiring 12 comprises n signal lines 12-1 through 12-n. The wiring 22 comprises n signal lines 22-1 through 22-n. The wiring 32 comprises n signal lines 32-1 through 32-n.

The terminal 44-1 of the variable wiring element 40 is connected via the corresponding signal line 12-1 to the corresponding terminal 16-1 of the variable logic element 10, and connected via the corresponding signal line 22-1 to the corresponding terminal 26-1 of the variable logic element 20, and further connected via the corresponding signal line 32-1 to the corresponding terminal 36-1 of the variable logic element 30, in one-to-three correspondence.

As such, each of the terminals 44-2 through 44-n of the variable wiring element 40 is connected through each three of the corresponding signal lines 12-2 through 12-n, 22-2 through 22-n, 32-2 through 32-n to each three of the corresponding terminals 16-2 through 16-n, 26-2 through 26-n, 36-2 through 36-n of the variable logic elements 10, 20, and 30, in one-to-three correspondence.

Thus, according to the present embodiment, in a case that as a result of dividing of the under-verification circuit, there is any difference in the number of signal lines between the variable logic element 10 and the variable wiring element 40, the number of signal lines between the variable logic element 20 and the variable wiring element 40, and the number of signal lines between the variable logic element 30 and the variable wiring element 40, the following connection is realized.

That is, depending on the necessary number of signal lines between each of the variable logic elements 10, 20, and 30 and the variable wiring element 40, necessary signal lines are selected and used from the signal lines 12-1 through 12-n, 22-1 through 22-n, 32-1 through 32-n.

At this time, signal lines not used among the signal lines 12-1 through 12-n, 22-1 through 22-n, 32-1 through 32-n are electrically disconnected from the variable logic elements 10, 20, and 30. That is, the outputs from the terminals of the variable logic elements 10, 20, and 30 connected to the signal lines not used are maintained at a high impedance.

Thus, when the variable logic elements 10, 20, and 30 are connected to the variable wiring element 40, the above-mentioned configuration allows appropriate and efficient use of the signal lines corresponding to the result of dividing of the under-verification circuit.

These points are described below with reference to specific examples. A first example of use is described.

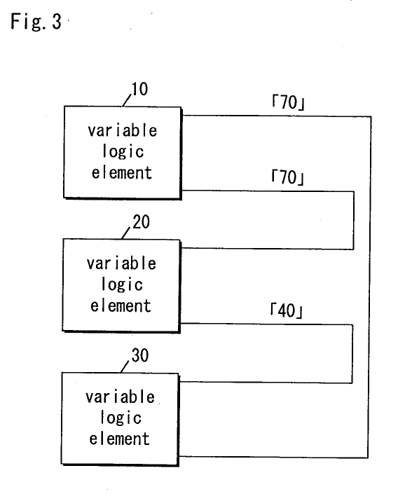

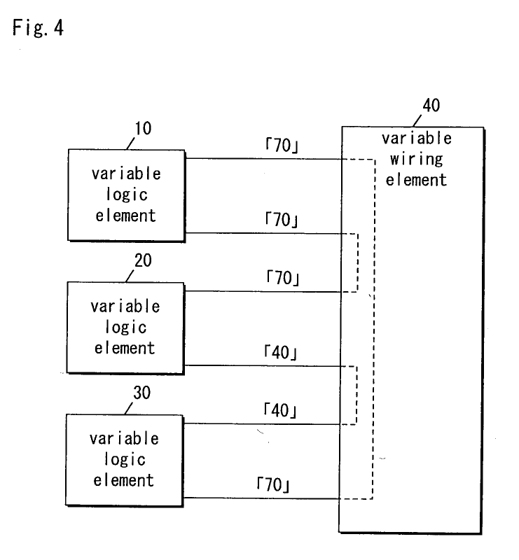

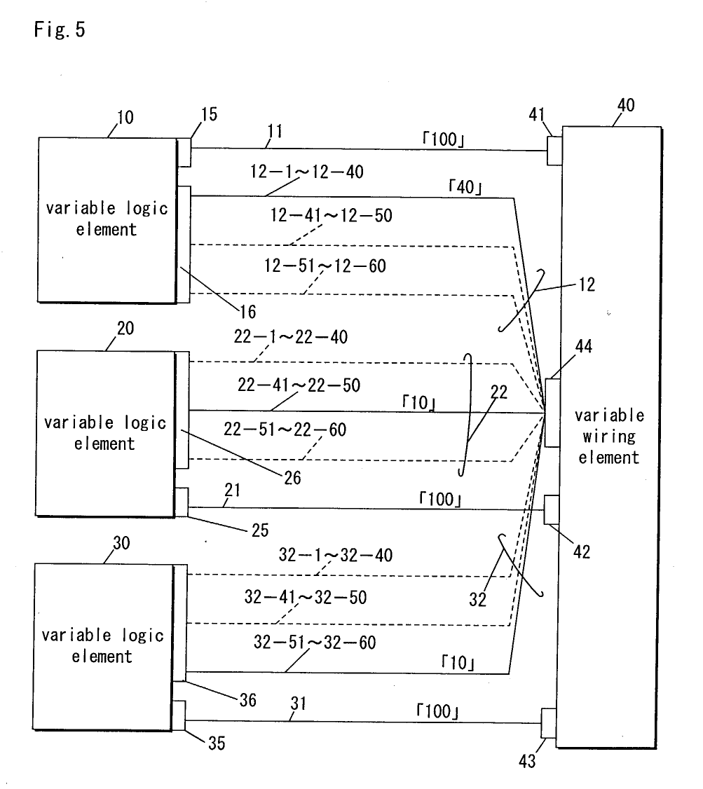

FIG. 3, FIG. 4, and FIG. 5 illustrate the first example of use of the logic emulator 1 according to the present embodiment. In FIG. 3, FIG. 4, and FIG. 5, the same parts as in FIG. 1 are designated by the same reference numbers. Some parts are omitted.

In the first example of use, the number m of the signal lines of each of the wirings 11, 21, and 31 is assumed to be 100.

Further, in the first example of use, the number n of the signal lines of each of the wirings 12, 22, and 32 is assumed to be 60.

Accordingly, the maximum number of signal lines available as variable wirings employed by the variable wiring element 40 is 360.

In other words, each of the terminal groups 41, 42, and 43 of the variable wiring element 40 comprises 100 terminals, while the terminal group 44 comprises 60 terminals 44-1 through 44-60 (see FIG. 2). Further, the variable wiring element 40 can employ 360 terminals for variable wirings at maximum.

Here, the terminal group 15 of the variable logic element 10 comprises 100 terminals, while the terminal group 16 comprises 60 terminals 16-1 through 16-60 (see FIG. 2). The terminal group 25 of the variable logic element 20 comprises 100 terminals; while the terminal group 26 comprises 60 terminals 26-1 through 26-60 (see FIG. 2). The terminal group 35 of the variable logic element 30 comprises 100 terminals, while the terminal group 36 comprises 60 terminals 36-1 through 36-60 (see FIG. 2).

On the other hand, in the first example of use as shown in FIG. 3, as a result of dividing of the under-verification circuit, it is assumed that the number of necessary signal lines between the variable logic element 10 and the variable logic element 30 is 70, that the number of necessary signal lines between the variable logic element 10 and the variable logic element 20 is 70, and that the number of necessary signal lines between the variable logic element 20 and the variable logic element 30 is 40.

In such a case, these signal lines need to be connected via the variable wiring element 40 as shown in FIG. 4.

As a result, the number of necessary signal lines between each of the variable logic elements 10, 20, and 30 and the variable wiring element 40 is 140, 110, and 110, respectively.

In this case, as shown in FIG. 5, the variable logic element 10 uses the 100 signal lines of the wiring 11 and the 40 signal lines 12-1 through 12-40 of the wiring 12. The variable logic element 20 uses the 100 signal lines of the wiring 21 and the 10 signal lines 22-41 through 22-50 of the wiring 22. The variable logic element 30 uses the 100 signal lines of the wiring 31 and the 10 signal lines 32-51 through 32-60 of the wiring 32.

Described below first is the point that the variable logic element 10 uses the 100 signal lines of the wiring 1 and the 40 signal lines 12-1 through 12-40 of the wiring 12 as shown in FIG. 5.

In this case, the variable logic element 10 uses the 100 signal lines of the wiring 11 for connecting the 100 terminals of the terminal group 41 of the variable wiring element 40 and the 100 terminals of the terminal group 15 of the variable logic element 10 in one-to-one correspondence.

Further, the variable logic element 10 uses the 40 signal lines 12-1 through 12-40 of the wiring 12 for connecting the 40 terminals 44-1 through 44-40 of the terminal group 44 of the variable wiring element 40 and the 40 terminals 16-1 through 16-40 of the terminal group 16 of the variable logic element 10 in one-to-one correspondence (see FIG. 2 and FIG. 5).

The other signal lines 22-1 through 22-40 and 32-1 through 32-40 connected to the 40 terminals 44-1 through 44-40 of the variable wiring element 40 are electrically disconnected from the variable logic elements 20 and 30 (see FIG. 2 and FIG. 5).

That is, the outputs from the 40 terminals 26-1 through 26-40 of the terminal group 26 of the variable logic element 20 connected to the terminals 44-1 through 44-40 of the variable wiring element 40 used solely by the variable logic element 10 and not used by the variable logic element 20 are maintained at a high impedance, while the outputs from the 40 terminals 36-1 through 36-40 of the terminal group 36 of the variable logic element 30 connected to the terminals 44-1 through 44-40 of the variable wiring element 40 used solely by the variable logic element 10 and not used by the variable logic element 30 are maintained at a high impedance (see FIG. 2 and FIG. 5).

Described next is the point that the variable logic element 20 uses the 100 signal lines of the wiring 21 and the 10 signal lines 22-41 through 22-50 of the wiring 22 as shown in FIG. 5.

In this case, the variable logic element 20 uses the 100 signal lines of the wiring 21 for connecting the 100 terminals of the terminal group 42 of the variable wiring element 40 and the 100 terminals of the terminal group 25 of the variable logic element 20 in one-to-one correspondence.

Further, the variable logic element 20 uses the 10 signal lines 22-41 through 22-50 of the wiring 22 for connecting the 10 terminals 44-41 through 44-50 of the terminal group 44 of the variable wiring element 40 and the 10 terminals 26-41 through 26-50 of the terminal group 26 of the variable logic element 20 in one-to-one correspondence (see FIG. 2 and FIG. 5).

The other signal lines 12-41 through 12-50 and 32-41 through 32-50 connected to the 10 terminals 44-41 through 44-50 of the variable wiring element 40 are electrically disconnected from the variable logic elements 10 and 30 (see FIG. 2 and FIG. 5).

That is, the outputs from the 10 terminals 16-41 through 16-50 of the terminal group 16 of the variable logic element 10 connected to the terminals 44-41 through 44-50 of the variable wiring element 40 used solely by the variable logic element 20 and not used by the variable logic element 10 are maintained at a high impedance, while the outputs from the 10 terminals 36-41 through 36-50 of the terminal group 36 of the variable logic element 30 connected to the terminals 44-41 through 44-50 of the variable wiring element 40 used solely by the variable logic element 20 and not used by the variable logic element 30 are maintained at a high impedance (see FIG. 2 and FIG. 5).

Described next is the point that the variable logic element 30 uses the 100 signal lines of the wiring 31 and the 10 signal lines 32-51 through 32-60 of the wiring 32 as shown in FIG. 5.

In this case, the variable logic element 30 uses the 100 signal lines of the wiring 31 for connecting the 100 terminals of the terminal group 43 of the variable wiring element 40 and the 100 terminals of the terminal group 35 of the variable logic element 30 in one-to-one correspondence.

Further, the variable logic element 30 uses the 10 signal lines 32-51 through 32-60 of the wiring 32 for connecting the 10 terminals 44-51 through 44-60 of the terminal group 44 of the variable wiring element 40 and the 10 terminals 36-51 through 36-60 of the terminal group 36 of the variable logic element 30 in one-to-one correspondence (see FIG. 2 and FIG. 5).

The other signal lines 12-51 through 12-60 and 22-51 through 22-60 connected to the 10 terminals 44-51 through 44-60 of the variable wiring element 40 are electrically disconnected from the variable logic elements 10 and 20 (see FIG. 2 and FIG. 5).

That is, the outputs from the 10 terminals 16-51 through 16-60 of the terminal group 16 of the variable logic element 10 connected to the terminals 44-51 through 44-60 of the variable wiring element 40 used solely by the variable logic element 30 and not used by the variable logic element 10 are maintained at a high impedance, while the outputs from the 10 terminals 26-51 through 26-60 of the terminal group 26 of the variable logic element 20 connected to the terminals 44-51 through 44-60 of the variable wiring element 40 used solely by the variable logic element 30 and not used by the variable logic element 20 are maintained at a high impedance (see FIG. 2 and FIG. 5).

Such configuration allows appropriate connection between the variable logic elements 10, 20, and 30 via the variable wiring element 40. Further, all the connection paths between the variable logic elements 10, 20, and 30 pass through the variable wiring element 40. This reduces variation of signal delay between the wirings 11, 12, 21, 22, 31, and 32.

Described above is the first example Of use. A second example of use is described below.

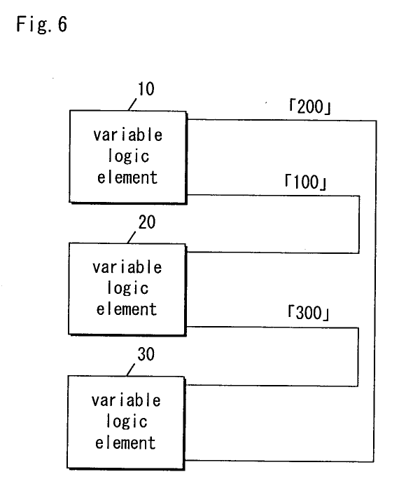

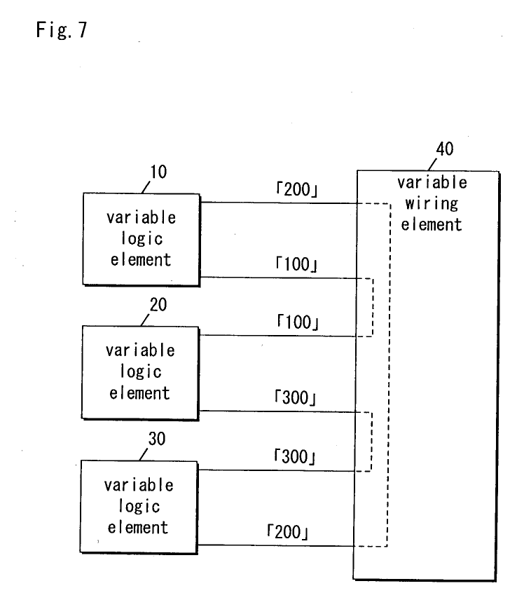

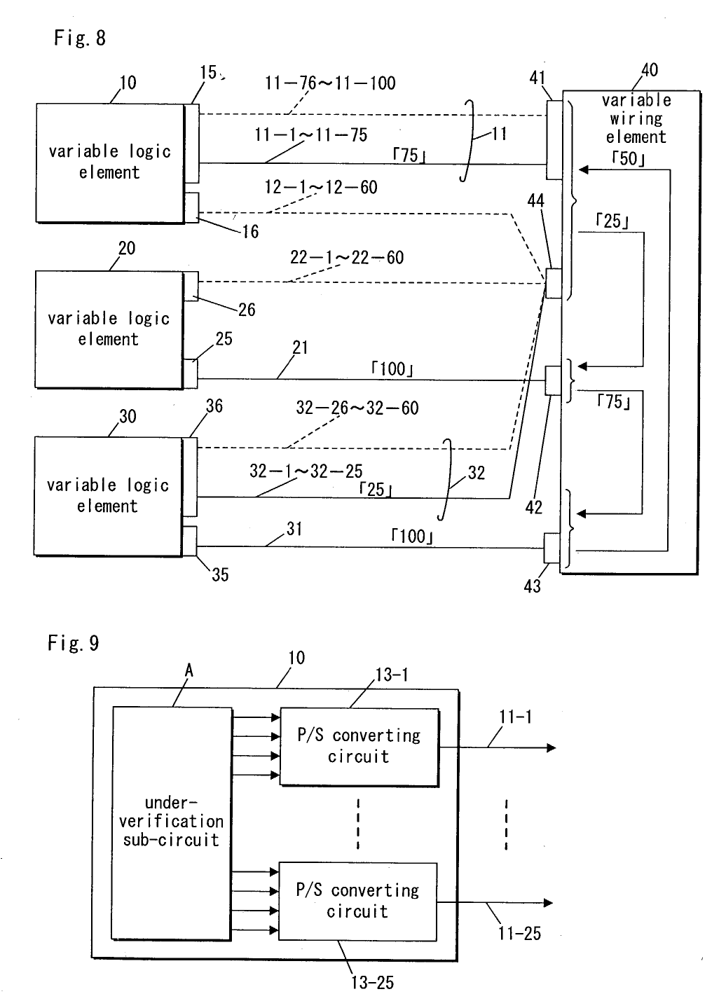

FIG. 6, FIG. 7, and FIG. 8 illustrate the second example of the use of the logic emulator 1 according to the present embodiment. In FIG. 6, FIG. 7, and FIG. 8, the same parts as in FIG. 1 are designated by the same reference numbers. Some parts are omitted.

In the second example of use, the number m of the signal lines of each of the wirings 11, 21, and 31, as shown in FIG. 1, is assumed to be 100.

Further, in the second example of use, the number n of the signal lines of each of the wirings 12, 22, and 32, as shown in FIG. 1, is assumed to be 60.

Accordingly, the maximum number of signal lines available as variable wirings employed by the variable wiring element 40 is 360.

In other words, each of the terminal groups 41, 42, and 43 of the variable wiring element 40 comprises 100 terminals, while the terminal group 44 comprises 60 terminals 44-1 through 44-60 (see FIG. 2). Further, the variable wiring element 40 can use 360 terminals for variable wirings at maximum.

These assumptions are the same as those of the first example of use. On the other hand, in the second example of use as shown in FIG. 6, as a result of dividing of the under-verification circuit, it is assumed that the number of necessary signal lines between the variable logic element 10 and the variable logic element 30 is 200, that the number of necessary signal lines between the variable logic element 10 and the variable logic element 20 is 100, and that the number of necessary signal lines between the variable logic element 20 and the variable logic element 30 is 300.

In such a case, these signal lines need to be connected via the variable wiring element 40 as shown in FIG. 7.

As a result, the number of necessary signal lines between each of the variable logic elements 10, 20, and 30 and the variable wiring element 40 is 300, 400, and 500, respectively.

In this case, the number of physical signal lines is insufficient. Thus, the signal lines between each of the variable logic elements 10, 20, and 30 and the variable wiring element 40 need to be used in time division multiplex for the connection between the variable logic elements 10, 20, and 30.

A specific method for transmitting signals the number of which exceeds the number of physical signal lines, between the variable logic elements 10, 20, and 30 in time division multiplex is described later.

When a plurality of signals are transmitted through a single signal line in time division multiplex, the situation that the number of signals transmitted through the signal line is fewer is obviously advantageous in the improvement of operation speed of the under-verification sub-circuits A, B, and C assigned to the variable logic elements 10, 20, and 30 of the logic emulator 1.

Accordingly, as shown in FIG. 8, it is assumed that the variable logic element 10 uses the 75 signal lines 11-1 through 11-75 among the 100 signal lines 11-1 through 11-100 of the wiring 111, that the variable logic element 20 uses the 100 signal lines of the wiring 21, and that the variable logic element 20 uses the 100 signal lines of the wiring 1 and the 25 signal lines 32-1 through 32-25 of the wiring 32.

In this case, the signal lines 11-76 through 32-25 through 12-60 not used by the variable logic element 10 are electrically disconnected from the variable logic element 10.

That is, the outputs from the 85 terminals of the terminal groups 15 and 16 of the variable logic element 10 connected to the signal lines 11-76 through 11-100 and 12-1 through 12-60 not used by the variable logic element 10 are maintained at a high impedance.

Further, the signal lines 22-1 through 22-60 not used by the variable logic element 20 are electrically disconnected from the variable logic element 20.

That is, the outputs from the 60 terminals of the terminal group 26 of the variable logic element 20 connected to the signal lines 22-1 through 22-60 not used by the variable logic element 20 are maintained at a high impedance.

Furthermore, the signal lines 32-26 through 32-60 not used by the variable logic element 30 are electrically disconnected from the variable logic element 30.

That is, the outputs from the 35 terminals of the terminal group 36 of the variable logic element 30 connected to the signal lines 32-26 through 32-60 not used by the variable logic element 30 are maintained at a high impedance.

As a result, the outputs from the 25 terminals 16-1 through 16-25 of the terminal group 16 of the variable logic element 10 connected to the terminals 44-1 through 44-25 of the variable wiring element 40 used solely by the variable logic element 30 and not used by the variable logic element 10 are maintained at a high impedance, while the outputs from the 25 terminals 26-1 through 26-25 of the terminal group 26 of the variable logic element 20 connected to the terminals 44-1 through 44-25 of the variable wiring element 40 used solely by the variable logic element 30 and not used by the variable logic element 20 are maintained at a high impedance (see FIG. 2 and FIG. 8).

The above-mentioned assigning of the signal lines used by the variable logic elements 10, 20, and 30 allows time division multiplex where signals for four signal lines are transmitted through a single signal line.

Here, it is assumed that the number of signal lines between each of the variable logic elements 10, 20, and 30 and the variable wiring element 40 is fixed to be ⅓ of the maximum value of the number of terminals for the variable wirings of the variable wiring element 40, that is, to be 120.

With this assumption, it is necessary that signals for five signal lines are transmitted by time division multiplex through a single signal line between the variable logic element 30 and the variable wiring element 40.

As described above, according to the present embodiment, the number of signal lines available between each of the variable logic elements 10, 20, and 30 and the variable wiring element 40 becomes variable. This allows appropriate time division multiplex, and hence improves the operation speed of the under-verification sub-circuits A, B, and C assigned to the variable logic elements 10, 20, and 30 of the logic emulator 1.

Described below is a specific method of time division multiplex of signals. Description is made for the case that signals for four signal lines (referred to as “parallel data,” hereinafter in this example) are time-division multiplexed by the variable logic element 10 of FIG. 1 and thereby transmitted through a single signal line. In this example, the variable logic element 10 uses the signal lines 11-1 through 11-25 shown in FIG. 8.

FIG. 9 is a block diagram of the variable logic element 10 for emulating the function of time division multiplex of the parallel data. In FIG. 9, the same parts as in FIG. 1 and FIG. 8 are designated by the same reference numbers.

As shown in FIG. 9, for the purpose of time division multiplex of the parallel data, logic for constituting parallel/serial converting circuits (referred to as “P/S converting circuits,” hereinafter) 13-1 through 13-25 is set to the variable logic element 10.

In this case, the P/S converting circuit 13-1 performs parallel/serial conversion of the corresponding parallel data from the under-verification sub-circuit A into serial data, and thereby outputs the data sequentially to the corresponding single signal line 11-1 at a predetermined period.

Similarly, each of the P/S converting circuits 13-2 through 13-25 performs parallel/serial conversion of the corresponding parallel data from the under-verification sub-circuit A into serial data, and thereby outputs the data sequentially to each of the corresponding single signal lines 11-2 through 11-25 at a predetermined period.

As a result, signals the number of which exceeds the number of physical signal lines are transmitted between the variable logic elements 10, 20, and 30 in time division multiplex.

Described below is a specific method for recovering the time-division multiplexed signals into original signals.

Description is made for the case that signals generated by the time division multiplex of signals for four signal lines (referred to as “serial data,” hereinafter in this example) are received through a single signal line and then recovered into the original signals for four signal lines (referred to as “parallel data,” hereinafter in this example) in the variable logic element 10 of FIG. 1. In this example, the variable logic element 10 uses the signal lines 11-26 through 11-75 shown in FIG. 8.

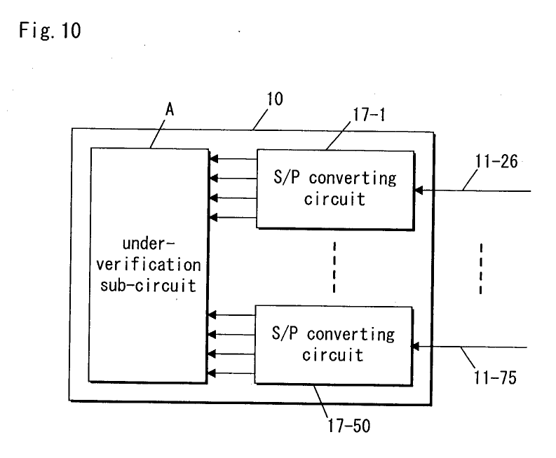

FIG. 10 is a block diagram of the variable logic element 10 for emulating the function of recovering the serial data into the original parallel data. In FIG. 10, the same parts as in FIG. 1 and FIG. 8 are designated by the same reference numbers.

As shown in FIG. 10, in order to recover the serial data into the original parallel data, logic for constituting serial/parallel converting circuits (referred to as “S/P converting circuits,” hereinafter) 17-1 through 17-50 is set to the variable logic element 10.

In this case, the S/P converting circuit 17-1 performs serial/parallel conversion of the serial data from the corresponding signal line 11-26 into the original parallel data, and then outputs the data to the under-verification sub-circuit A.

Similarly, each of the S/P converting circuits 17-2 through 17-50 performs serial/parallel conversion of the serial data from each of the corresponding signal line 11-27 through 11-75 into the original parallel data, and then outputs the data to the under-verification sub-circuit A.

As a result, the time-division multiplexed signals are converted into the original signals.

As described above, in the present embodiment, each of the terminals 44-1 through 44-n of the terminal group 44 of the variable wiring element 40 is connected to each three of the corresponding signal lines 12-1 through 12-n, 22-1 through 22-n, 32-1 through 32-n between the three variable logic elements 10, 20, and 30.

By virtue of this, the signal lines 12-1 through 12-n, 22-1 through 22-n, 32-1 through 32-n connected to the terminals 44-1 through 44-n of the terminal group 44 of the variable wiring element 40 can be used by any of the variable logic elements 10, 20, and 30. That is, the number of signal lines available for each of the variable logic elements 10, 20, and 30 is variable. Thus, depending on the number of signal lines used by each of the variable logic elements 10, 20, and 30 determined by the result of dividing of the under-verification circuit, the signal lines are selectively used. Thus, without an increase in the variable wiring elements, wastefulness and deficiency in the signal lines for the variable logic elements 10, 20, and 30 are suppressed as much as possible. This allows efficient use of the signal lines.

As a result, suppressed as much as possible are: cost increase caused by the increase in the variable wiring elements; signal transmission delay between the variable logic elements 10, 20, and 30 caused by excessive time division multiplex necessary due to deficiency in the signal lines; and decrease in the operation speed of under-verification sub-circuits A, B, and C caused by the above-mentioned delay in signal transmission.

Further, avoided is a complicated process of dividing the under-verification circuit in such a manner that the number of signal lines necessary for connection between each of the under-verification sub-circuits A, B, and C assigned to each of the variable logic elements 10, 20, and 30 agrees with the number of signal lines between each of the variable logic elements 10, 20, and 30 and the variable wiring element 40.

As a result, suppressed as much as possible are: an increase in the process time for dividing the under-verification circuit; and wastefulness caused by the occurrence of variation in the rate of use of internal circuits among the variable logic elements 10, 20, and 30.

The variable logic elements may be composed of, for example, FPGAs (Field Programmable Gate Arrays).

The number of variable logic elements is not limited to three. The present embodiment is applicable to any number of variable logic elements.

The variable wiring elements may be composed of, for example, FPIDs (Field Programmable Interconnect Devices).

Further, the number of variable wiring elements is not limited to one. The present embodiment is applicable to any number of variable wiring elements.

(Embodiment 2)

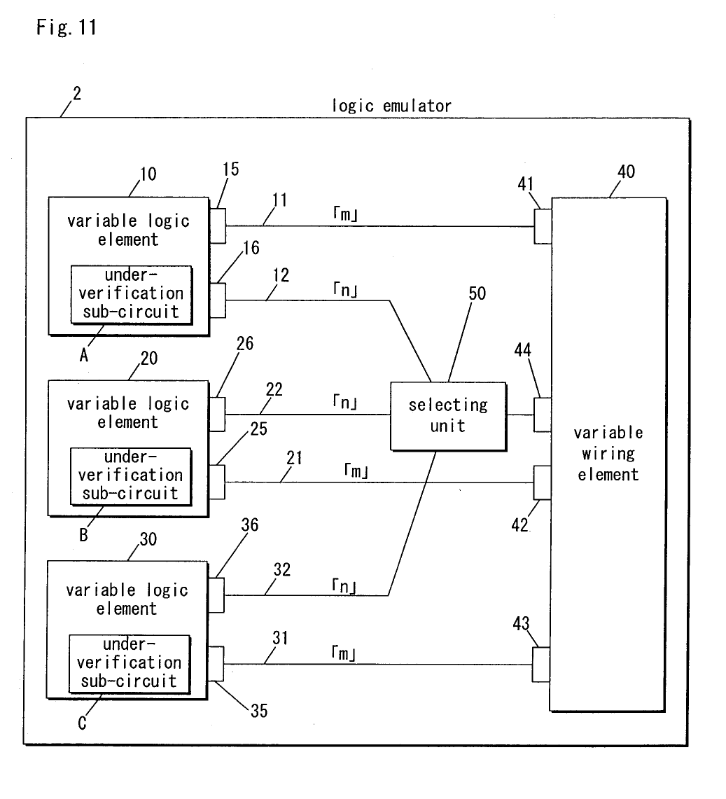

FIG. 11 is a block diagram of a logic emulator 2 according to Embodiment 2 of the invention. In FIG. 11, the same parts as in FIG. 1 are designated by the same reference numbers, and hence the description thereof is omitted if appropriate.

As shown in FIG. 11, the logic emulator 2 according to Embodiment 2 comprises a selecting unit 50 in addition to the configuration of the logic emulator 1 of FIG. 1.

Accordingly, in the logic emulator 2 according to Embodiment 2, the wirings 12, 22, and 32 from the variable logic elements 10, 20, and 30 are connected to the terminal group 44 via the selecting unit 50. This point is described below in detail.

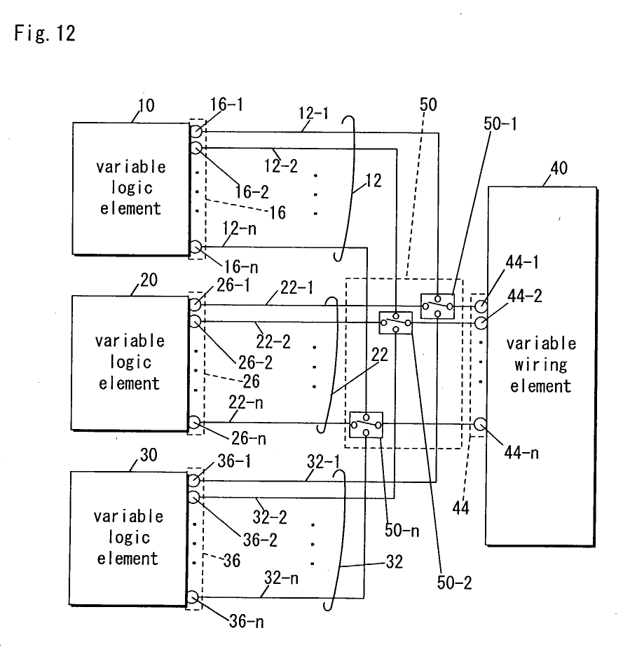

FIG. 12 is a view illustrating the detail of the wirings of FIG. 11. In FIG. 12, the same parts as in FIG. 11 are designated by the same reference numbers. Further, in FIG. 12, illustration of the terminal groups 15, 25, 35, and 41 through 43 shown in FIG. 11 is omitted. Furthermore, in FIG. 12, the same parts as in FIG. 2 are designated by the same reference numbers, and hence the description thereof is omitted if appropriate.

As shown in FIG. 12, the selecting unit 50 comprises switches 50-1 through 50-n corresponding to the terminals 44-1 through 44-n of the terminal group 44.

The switch 50-1 is connected via the corresponding signal line 12-1 to the corresponding terminal 16-1 of the variable logic element 10, and connected via the corresponding signal line 22-1 to the corresponding terminal 26-1 of the variable logic element 20, and further connected via the corresponding signal line 32-1 to the corresponding terminal 36-1 of the variable logic element 30, in one-to-three correspondence.

The switch 50-1 is further connected to the corresponding terminal 44-1 of the variable wiring element 40.

As such, each of the switches 50-2 through 50-n is connected via each three of the corresponding signal lines 12-2 through 12-n, 22-2 through 22-n, 32-2 through 32-n to each three of the corresponding terminals 16-2 through 16-n, 26-2 through 26-n, 36-2 through 36-n of the variable logic elements 10, 20, and 30, in one-to-three correspondence.

Each of the switches 50-2 through 50-n is further connected to each of the corresponding terminals 44-2 through 44-n of the variable wiring element 40.

Each of the switches 50-1 through 50-n selects a signal line used by each of the variable logic elements 10, 20, and 30 from the three signal lines, and thereby connects the signal line to the corresponding terminal of the variable wiring element 40.

Described below are the function and the operation of the switches 50-1 through 50-n.

The switch 50-1 selects any one of the signal line 12-1, the signal line 22-1, and the signal line 32-1, and thereby connects the selected signal line to the corresponding terminal 44-1.

Similarly, each of the switches 50-2 through 50-n selects any one from each three of the corresponding signal lines 12-2 through 12-n, 22-2 through 22-n, 32-2 through 32-n, and thereby connects the selected signal line to each of the corresponding terminals 44-2 through 44-n.

This configuration avoids malfunction of the circuits of the logic emulator 2, and further reduces power consumption. This point is described below with reference to a specific example.

When the switch 50-1 selects the signal line 12-1 connected to the variable logic element 10 and thereby connects the signal line to the terminal 44-1 of the variable wiring element 40, the other signal lines 22-1 and 32-1 connected to the variable logic elements 20 and 30 are electrically disconnected from the signal transmission path formed by the signal line 12-1, the switch 50-1, and the terminal 44-1 of the variable wiring element 40.

Accordingly, in the signal transmission path formed by the signal line 12-1, the switch 50-1, and the terminal 44-1 of the variable wiring element 40, suppressed as much as possible is the influence of signal reflection which could occur if the signal lines 22-1 and 32-1 were not electrically disconnected.

This avoids malfunction of the circuit. Further, since the signal lines 22-1 and 32-1 are electrically disconnected from the signal transmission path, the load of the signal transmission path is reduced. This reduces power consumption during operation.

As such, signal lines not used among the signal lines 12-1 through 12-n, 22-1 through 22-n, 32-1 through 32-n are disconnected from the terminals 44-1 through 44-n of the variable wiring element 40 by the switches 50-1 through 50-n, while signal lines used are solely connected to the terminals 44-1 through 44-n of the variable wiring element 40 by the switches 50-1 through 50-n.

Further, similarly to Embodiment 1, signal lines not used among the signal lines 12-1 through 12-n, 22-1 through 22-n, 32-1 through 32-n are electrically disconnected from the variable logic elements 10, 20, and 30.

That is, similar to Embodiment 1, the outputs from the terminals connected to the signal lines not used among the terminals 16-1 through 16-n, 26-1 through 26-n, 36-1 through 36-n of the variable logic elements 10, 20, and 30 are maintained at a high impedance.

Here, similar to Embodiment 1, signal lines not used among the signal lines of the wirings 11, 21, and 31 of FIG. 11 are electrically disconnected from the variable logic elements 10, 20, and 30.

That is, similar to Embodiment 1, the outputs from the terminals connected to the signal lines not used among the terminals of the terminal groups 15, 25, and 35 of the variable logic elements 10, 20, and 30 are maintained at a high impedance.

As such, according to the present embodiment, each of the switches 50-1 through 50-n selects one signal line from each three of the corresponding signal lines 12-1 through 12-n, 22-1 through 22-n, 32-1 through 32-n among the three variable logic elements 10, 20, and 30, and thereby connects the selected signal line to each of the corresponding terminals 44-1 through 44-n of the terminal group 44 of the variable wiring element 40.

Thus, signal lines coming from the variable logic elements and not selected by the switches 50-1 through 50-n are disconnected from the terminals 44-1 through 44-n of the terminal group 44 of the variable wiring element 40.

As a result, suppressed are: signal disturbance caused by the connection of excessive signal lines; and an increase in the power consumption of the device caused by the stray capacitance of excessive signal lines.

The logic emulator 2 according to the present embodiment comprises all the configuration of the logic emulator 1 according to Embodiment 1. Accordingly, the present embodiment also has effects similar to those of Embodiment 1.

The number of variable logic elements is not limited to three. The present embodiment is applicable to any number of variable logic elements.

Further, the number of variable wiring elements is not limited to one. The present embodiment is applicable to any number of variable wiring elements.

(Embodiment 3)

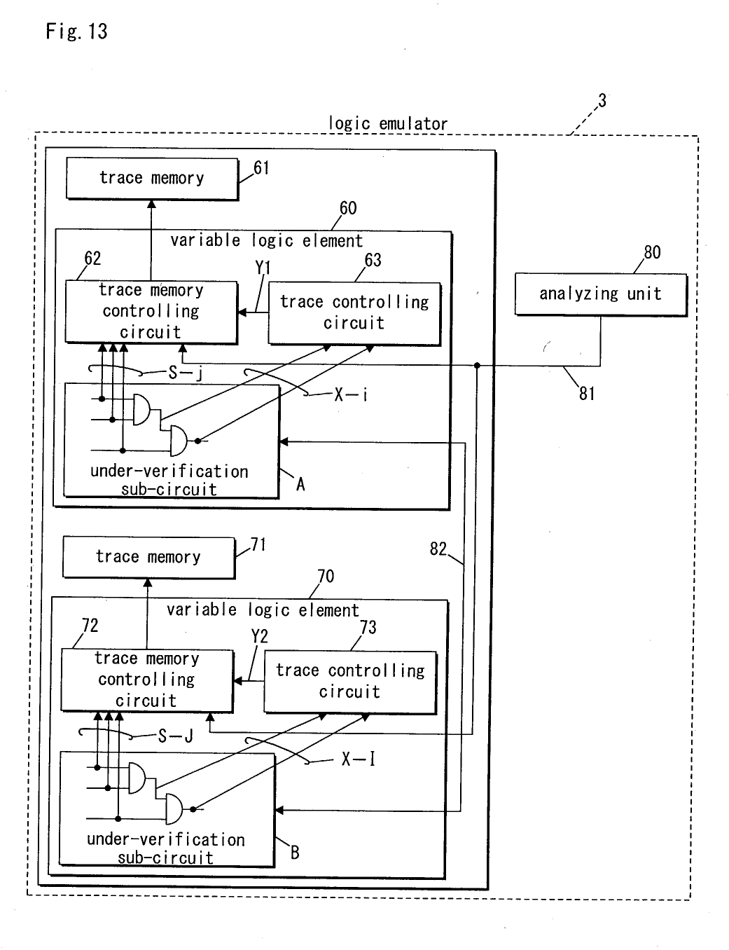

FIG. 13 is a block diagram of a logic emulator according to Embodiment 3 of the invention.

As shown in FIG. 13, the logic emulator 3 comprises trace memories 61 and 71, variable logic elements 60 and 70, and an analyzing unit 80. The two trace memories 61 and 71 are provided correspondingly to the two variable logic elements 60 and 70, respectively.

The variable logic element 60 comprises a trace memory controlling circuit 62 and a trace controlling circuit 63.

The variable logic element 70 comprises a trace memory controlling circuit 72 and a trace controlling circuit 73.

An under-verification sub-circuit A obtained by dividing the under-verification circuit is assigned to the variable logic element 60. An under-verification sub-circuit B obtained by dividing the under-verification circuit is assigned to the variable logic element 70.

The analyzing unit 80 and the trace memory controlling circuits 62 and 72 of the variable logic elements 60 and 70 are connected by a wiring 81. The wiring 81 comprises a plurality of signal lines.

The wiring 81 is used by the analyzing unit 80 for accessing the trace memory controlling circuits 62 and 72 of the variable logic elements 60 and 70.

The under-verification sub-circuit A assigned to the variable logic element 60 and the under-verification sub-circuit B assigned to the variable logic element 70 are connected by a wiring 82. The wiring 82 comprises a plurality of signal lines.

Described below are the function and operation of each component.

The variable logic elements 60 and 70 are elements the logic emulated in the inside of which can be altered from the outside, and thereby emulate the function based on the logic having been set. That is, the variable logic elements 60 and 70 are similar to the variable logic elements 10, 20, and 30 of FIG. 1.

The trace memories 61 and 71 store, at predetermined time intervals, information indicated by specified internal signals (referred to as “observing internal signals,” hereinafter in the embodiment) S-j and S-J of the under-verification sub-circuits A and B assigned to the corresponding variable logic elements 60 and 70. The trace memories 61 and 71 are connected directly to the variable logic elements 60 and 70.

The observing internal signal S-j as a whole indicates a plurality of observing internal signals S-1, S-2, . . . from the under-verification sub-circuit A. The observing internal signal S-J as a whole indicates a plurality of observing internal signals S-1, S-2, from the under-verification sub-circuit B.

Each of the trace memories 61 and 71 is composed, for example, of an SRAM (Static Random Access Memory).

In order to store the information indicated by the observing internal signals of the under-verification sub-circuits A and B into the corresponding trace memories 61 and 71, the trace memory controlling circuits 62 and 72 output addresses, data (observing internal signals S-j and S-J), read/write signals, and the like to the corresponding trace memories 61 and 71.

The trace controlling circuits 63 and 73 store trigger conditions. The trace controlling circuits 63 and 73 monitor signals (referred to as “trigger source signals,” hereinafter in the embodiments) X-i and X-I which are in the inside of the under-verification sub-circuits A and B and which are used for comparison with the stored trigger conditions. As a result of a comparison with the stored trigger conditions, when the trigger conditions hold, the trace controlling circuits 63 and 73 generate signals (referred to as “trigger signals,” hereinafter in the present embodiment) Y1 and Y2 for instructing the trace memory controlling circuits 62 and 72 to start or stop the storing of information indicated by the observing internal signals S-j and S-J into the corresponding trace memories 61 and 71.

In response to the trigger signals Y1 and Y2 generated by the trace controlling circuits 63 and 73, the trace memory controlling circuits 62 and 72 control the start or stop of storing of information indicated by the observing internal signals S-j and S-J into the corresponding trace memories 61 and 71.

The trigger source signal X-i as a whole indicates a plurality of trigger source signals X-1, X-2, from the under-verification sub-circuit A. The trigger source signal X-1 as a whole indicates a plurality of trigger source signals X-1, X-2, from the under-verification sub-circuit B.

The analyzing unit 80 reads out the information indicated by the observing internal signals S-j and S-J stored in the trace memories 61 and 71, via the trace memory controlling circuits 62 and 72 and the wiring 81, and thereby analyzes the information. The analyzing unit 80 is composed, for example, of a workstation.

The number of trigger source signals for a single variable logic element can reach several tens in some cases.

In such a case, when trace controlling circuits are provided outside the variable logic elements, these several tens trigger source signals need to be extracted to the outside of the variable logic elements.

In this case, since the number of terminals of the variable logic elements is limited, the number of terminals and the number of signal lines to be used for connection between the under-verification sub-circuits of the variable logic elements are reduced, and in some cases, become insufficient.

In contrast, in the present embodiment, the trace controlling circuits 63 and 73 are provided inside the variable logic elements 60 and 70, whereby judgment of the trigger conditions is performed inside the variable logic elements 60 and 70. Thus, the number of terminals and the number of signal lines of the wiring 82 to be used for connection between the under-verification sub-circuits A and B of the variable logic elements 60 and 70 do not become insufficient due to the trigger source signals.

The operation of the logic emulator 3 according to the present embodiment is described below in further detail.

In the present embodiment, the under-verification circuit is emulated by being divided into two variable logic elements 60 and 70.

Observing internal signals S-j and S-J observed for debug of the under-verification circuit are provided through the trace memory controlling circuits 62 and 72 inside the variable logic elements 60 and 70 to the corresponding trace memories 61 and 71, and thereby stored there.

The start and stop of storing of information indicated by the observing internal signals S-j and S-J into the trace memories 61 and 71 are instructed from the corresponding trace controlling circuits 63 and 73 to the trace memory controlling circuits 62 and 72.

More specifically, the trace controlling circuits 63 and 73 compare the states of the inputted trigger source signals X-i and X-I with the storing-start trigger conditions having been set in advance in the trace controlling circuits 63 and 73. When they agree with each other (the storing-start trigger conditions have held), the trace controlling circuits 63 and 73 generate trigger signals Y1 and Y2 for instructing the trace memory controlling circuits 62 and 72 to start the storing of information indicated by the observing internal signals S-j and S-J into the corresponding trace memories 61 and 71.

On receiving, from the trace controlling circuits 63 and 73, the trigger signals Y1 and Y2 for instructing the start of storing of the observing internal signals S-j and S-J, the trace memory controlling circuits 62 and 72 perform sampling of the observing internal signals S-j and S-J at predetermined time intervals, and thereby output the signals to the corresponding trace memories 61 and 71.

In response to this, the trace memories 61 and 71 store the information indicated by the observing internal signals S-j and S-J provided from the corresponding trace memory controlling circuits 62 and 72.

Here, the observing internal signal S-j of the under-verification sub-circuit A assigned to the variable logic element 60 is stored in the corresponding trace memory 61 connected to the variable logic element 60, while the observing internal signal S-J of the under-verification sub-circuit B assigned to the variable logic element 70 is stored in the corresponding trace memory 71 connected to the variable logic element 70.

Thus, each trace memory does not store observing internal signals from the variable logic elements other than the corresponding variable logic element.

On the other hand, the trace controlling circuits 63 and 73 compare the states of the inputted trigger source signals X-i and X-I with the storing-stop trigger conditions having been set in advance in the trace controlling circuits 63 and 73. When they agree with each other (the storing-stop trigger conditions have held), the trace controlling circuits 63 and 73 generate trigger signals Y1 and Y2 for instructing the trace memory controlling circuits 62 and 72 to stop the storing of information indicated by the observing internal signals S-j and S-J into the corresponding trace memories 61 and 71.

On receiving, from the trace controlling circuits 63 and 73, the trigger signals Y1 and Y2 for instructing the stop of storing of the observing internal signals S-j and S-J, the trace memory controlling circuits 62 and 72 stop the sampling of the observing internal signals S-j and S-J, and thereby stop the output to the corresponding trace memories 61 and 71. That is, the storing of information indicated by the observing internal signals S-j and S-J is stopped.

The information indicated by the observing internal signals S-j and S-J stored in the trace memories 61 and 71 is read out through the wiring 81 by the analyzing unit 80, whereby the operation of the under-verification circuit is analyzed.

As described above, according to the present embodiment, in the variable logic elements 60 and 70, provided in the inside are: the trace controlling circuits 63 and 73 for instructing the storing (the start or stop of storing) of the information indicated by the observing internal signals S-j and S-J into the corresponding trace memories 61 and 71 on the basis of the trigger source signals X-i and X-I outputted from the under-verification sub-circuits A and B; and the trace memory controlling circuits 62 and 72 for controlling the storing (the start or stop of storing) of the information indicated by the observing internal signals S-j and S-J into the corresponding trace memories 61 and 71 according to the instructions from the trace controlling circuits 63 and 73.

This allows the control of the storing of information indicated by the observing internal signals S-j and S-J of the under-verification sub-circuits A and B, without the necessity that the trigger source signals X-i and X-I serving as the basis of the instruction of the storing of information indicated by the observing internal signals S-j and S-J of the under-verification sub-circuits A and B are outputted to the outside of the variable logic elements 60 and 70 or alternatively that the trigger signals Y1 and Y2 for instructing the storing are inputted from the outside.

Thus, the logic emulator 3 does not consume signal lines for the trigger source signals X-i and X-I and the trigger signals Y1 and Y2 for instructing the storing at the outside of the variable logic elements 60 and 70, while the variable logic elements 60 and 70 do not consume terminals for the output of the trigger source signals X-i and X-I and the input of the trigger signals Y1 and Y2 for instructing the storing.

This resolves, as much as possible, deficiency in the signal lines and in the terminals of the variable logic elements 60 and 70 used in the signal transmission between the variable logic elements 60 and 70 (between the under-verification sub-circuits A and B).

Here, the trace controlling circuits 63 and 73 are included within the concept of a “store instructing circuit” in the point that the trace controlling circuits 63 and 73 instruct the storing of information indicated by the observing internal signals S-j and S-J into the corresponding trace memories 61 and 71 on the basis of the trigger source signals X-i and X-I outputted from the under-verification sub-circuits A and B.

The variable logic elements may be composed of, for example, FPGAs (Field Programmable Gate Arrays).

The number of variable logic elements is not limited to two. The present embodiment is applicable to any number of variable logic elements.

Further, the present embodiment is also applicable to the case that the connection between the variable logic elements is implemented by a dedicated variable wiring element.

(Embodiment 4)

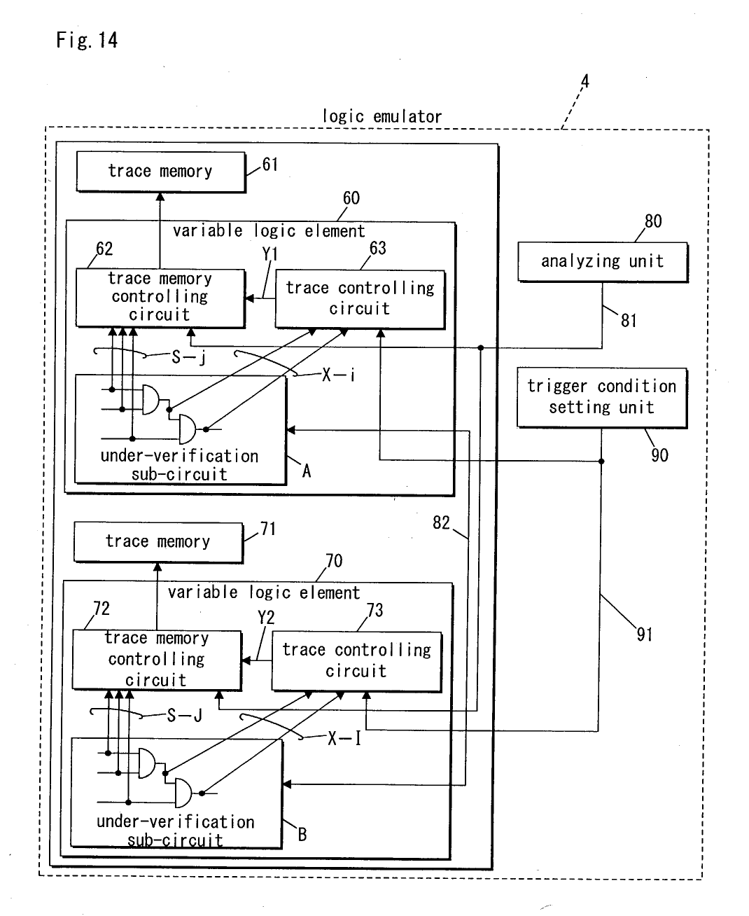

FIG. 14 is a block diagram of a logic emulator according to Embodiment 4 of the invention. In FIG. 14, the same parts as in FIG. 13 are designated by the same reference numbers, and hence the description thereof is omitted if appropriate.

As shown in FIG. 14, the logic emulator 4 according to Embodiment 4 comprises a trigger condition setting unit 90 in addition to the configuration of the logic emulator 3 of FIG. 13.

The trigger condition setting unit 90 is connected via a wiring 91 to the trace controlling circuits 63 and 73. The wiring 91 comprises a plurality of signal lines.

Then, the trigger condition setting unit 90 sets arbitrarily the trigger conditions of the trace controlling circuits 63 and 73 via the wiring 91.

The trace controlling circuits 63 and 73 are similar to the trace controlling circuits 63 and 73 according to Embodiment 3, and monitor the states of the trigger source signals X-i and X-I from the under-verification sub-circuits A and B. As a result of comparison with the stored trigger conditions, when the trigger conditions have held, the trace controlling circuits 63 and 73 generate trigger signals Y1 and Y2 for instructing the trace memory controlling circuits 62 and 72 to start or stop the storing of information indicated by the observing internal signals S-j and S-J into the corresponding trace memories 61 and 71.

The trigger condition setting unit 90 and the analyzing unit 80 can be composed of workstations.

The above-mentioned points are described below in further detail.

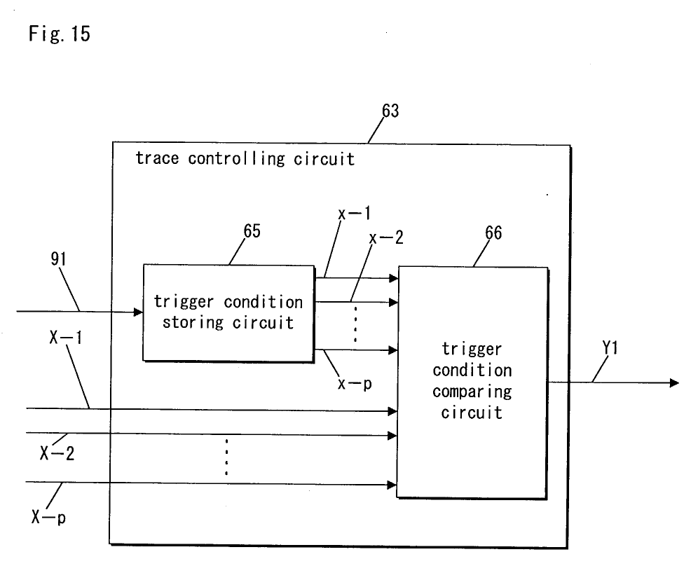

FIG. 15 is a block diagram of the trace controlling circuit 63 of FIG. 14. In FIG. 15, the same parts as in FIG. 14 are designated by the same reference numbers. Further, in the description of FIG. 15, the trigger source signal X-i as a whole indicates trigger source signals X-1, X-p.

As shown in FIG. 15, the trace controlling circuit 63 comprises a trigger condition storing circuit 65 and a trigger condition comparing circuit 66.

The trigger condition storing circuit 65 is connected via the wiring 91 to the trigger condition setting unit 90 of FIG. 14.

The trigger condition storing circuit 65 stores a trigger condition. The trigger condition is composed of a plurality of conditions corresponding to a plurality of trigger source signals X-1 through X-p.

That is, for each of the trigger source signals X-l through X-p, it is defined that when the information indicated by the trigger source signal is “1,” the logic of the trigger source signal is “true” (the condition holds), or alternatively that when the information indicated by the trigger source signal is “0,” the logic of the trigger source signal is “true” (the condition holds), or further alternatively that the logic of the trigger source signal is always “true” (the condition holds). When the logic of the trigger source signals X-1 through X-p is all “true,” the trigger condition is defined to hold.

That is, the trigger condition is a combination of the respective conditions of the trigger source signals X-1 through X-p (referred to as “individual conditions” in some cases hereinafter).

The trigger condition is set by the trigger condition setting unit 90, then provided via the wiring 91 to the trigger condition storing circuit 65, and stored there.

The trigger condition comparing circuit 66 acquires signals x-1 through x-p indicating the trigger condition, from the trigger condition storing circuit 65.

Here, the trigger condition setting unit 90 sets a storing-start trigger condition and a storing-stop trigger condition, whereby these are stored in the trigger condition storing circuit 65.

On the other hand, the trigger source signals X-1 through X-p are provided from the under-verification sub-circuit A to the trigger condition comparing circuit 66.

The trigger condition comparing circuit 66 then compares the signals x-1 through x-p indicating the trigger condition with the corresponding trigger source signals X-1 through X-p.

As a result of the comparison, when the individual conditions hold for all the trigger source signals X-1 through X-p, the trigger condition comparing circuit 66 concludes that the trigger condition holds, and thereby generates and outputs a trigger signal Y1 having the logic of “true” to the trace memory controlling circuit 62 of FIG. 14.

When the storing-start trigger condition holds, and thereby when the trigger signal Y1 having the logic of “true” is provided to the trace memory controlling circuit 62, the trace memory controlling circuit 62 controls the start of storing of the observing internal signal S-j.

On the contrary, when the storing-stop trigger condition holds, and thereby when the trigger signal Y1 having the logic of “true” is provided to the trace memory controlling circuit 62, the trace memory controlling circuit 62 controls the stop of storing of the observing internal signal S-j.

The setting of the trigger condition is described below with reference to a specific example.

For example, the trigger condition setting unit 90 can set and store, into the trigger condition storing circuit 65, a trigger condition that when the information indicated by the trigger source signal X-1 is “1,” the individual condition holds, that when the information indicated by the trigger source signal X-2 is “0,” the individual condition holds, and that for the trigger source signals X-3 through X-p, the individual conditions always hold.

This is merely an example, and hence the trigger condition setting unit 90 can set various trigger conditions composed of various combinations of the individual conditions.

As such, within the range of the signal of the under-verification sub-circuit A inputted in advance as the trigger source signal X-j into the trace controlling circuit 63, the trigger condition stored in the trigger condition storing circuit 65 can be rewritten arbitrarily by the trigger condition setting unit 90.

The configuration and function of the trace controlling circuit 73 of FIG. 14 are the same as those of the trace controlling circuit 63 of FIG. 15. Thus, the trigger condition for this circuit can also be rewritten arbitrarily by the trigger condition setting unit 90.

As described above, according to the present embodiment, the trigger condition for storing (the start or stop of storing) of the information indicated by the observing internal signals S-j and S-J of the under-verification sub-circuits A and B into the corresponding trace memories 61 and 71 can be set arbitrarily by the trigger condition setting unit 90.

This configuration reduces notably the frequency of occurrence of the necessity of: the compilation work of determining the internal circuit logic and the wiring arrangement of the variable logic elements 60 and 70; and the work of writing of circuit data into the variable logic elements 60 and 70; at each time when the trigger condition is changed. This allows smooth and fast verification of the under-verification circuit.

The logic emulator 4 according to the present embodiment comprises all the configurations and functions of the logic emulator 3 according to Embodiment 3. Accordingly, the logic emulator 4 according to the present embodiment also has effects similar to those of the logic emulator 3 according to Embodiment 3.

The variable logic elements may be composed of, for example, FPGAs (Field Programmable Gate Arrays).

The number of variable logic elements is not limited to two. The present embodiment is applicable to any number of variable logic elements.

Further, the present embodiment is applicable also to the case that the connection between the variable logic elements is implemented by a dedicated variable wiring element.

Furthermore, for example, the analyzing unit 80 and the trigger condition setting unit 90 can be integrated into a single workstation, whereby the wiring 81 and the wiring 91 can be made the same wiring. Alternatively, a part of these wirings may be made the same wiring.

(Embodiment 5)

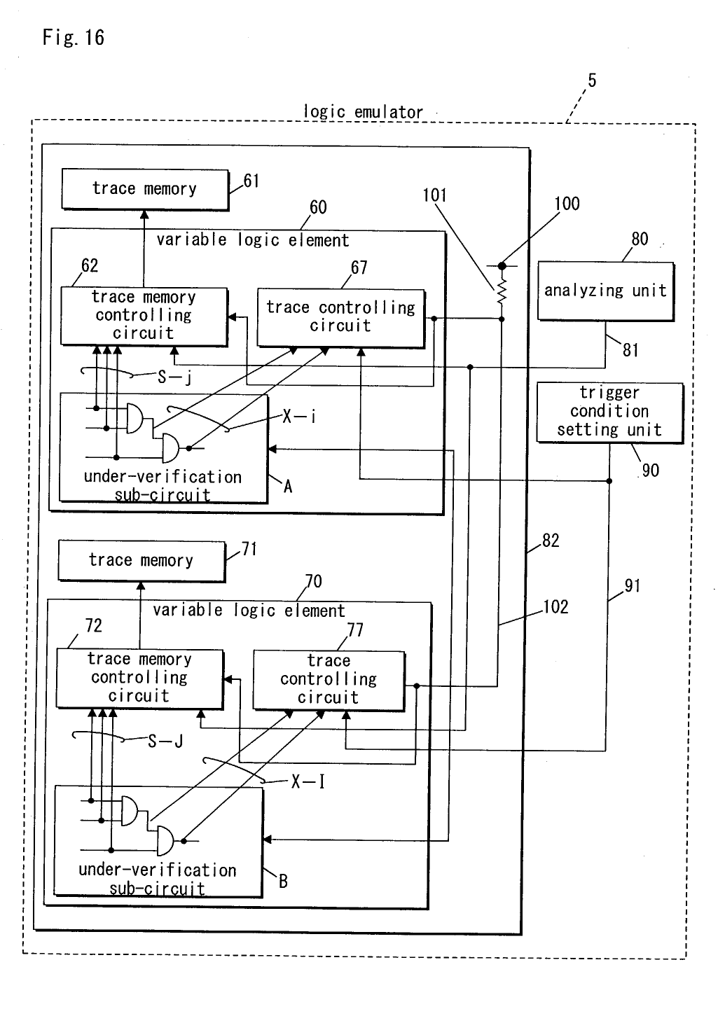

FIG. 16 is a block diagram of a logic emulator according to Embodiment 5 of the invention. In FIG. 16, the same parts as in FIG. 14 are designated by the same reference numbers, and hence the description thereof is omitted if appropriate.

As shown in FIG. 16, the logic emulator 5 according to Embodiment 5 comprises trace controlling circuits 67 and 77 in place of the trace controlling circuits 63 and 73 of the logic emulator 4 of FIG. 14, and further comprises a pull-up resistor 101.

The open collector outputs of the trace controlling circuits 67 and 77 are provided to a common wiring 102.

The common wiring 102 is connected to the pull-up resistor 101, while the pull-up resistor 101 is connected to a power supply 100.

The potential of the wiring 102 is provided to the trace memory controlling circuits 62 and 72, whereby the trace memory controlling circuits 62 and 72 are controlled integrally by the potential of the wiring 102.

As such, a wired logic is formed, whereby the trace memory controlling circuits 62 and 72 are controlled by the open collector outputs of the trace controlling circuits 67 and 77. This point is described below in detail.

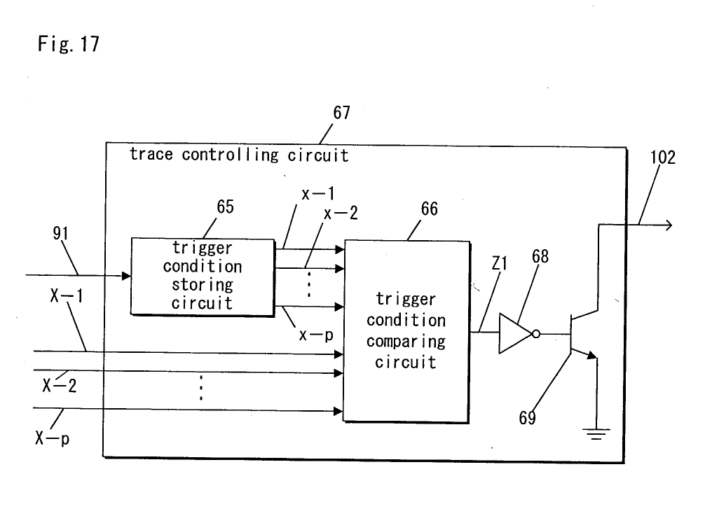

FIG. 17 is a block diagram of the trace controlling circuit 67 of FIG. 16. In FIG. 17, the same parts as in FIG. 15 are designated by the same reference numbers, and hence the description thereof is omitted if appropriate. Further, in FIG. 17, the same parts as in FIG. 16 are designated by the same reference numbers.

As shown in FIG. 17, the trace controlling circuit 67 comprises an inverter 68 and a transistor 69 in addition to the configuration of the trace controlling circuit 63 of FIG. 15.

The output signal Z1 of the trigger condition comparing circuit 66 (referred to as a “trigger control signal,” hereinafter in the present embodiment) is inputted to the inverter 68, thereby inverted, and then inputted to the base electrode of the transistor 69.

The collector electrode of the transistor 69 is connected to the wiring 102, while the emitter electrode is grounded. That is, the open collector output of the transistor 69 is provided to the wiring 102.

The configuration of the trace controlling circuit 77 of FIG. 16 is similar to that of the trace controlling circuit 67 of FIG. 17. Thus, the trigger condition storing circuit, the trigger condition comparing circuit, the inverter, and the transistor of the trace controlling circuit 77 are described below by using the same reference numbers as those of the trigger condition storing circuit 65, the trigger condition comparing circuit 66, the inverter 68, and the transistor 69 of the trace controlling circuit 67. However, the trigger control signal of the trigger condition comparing circuit 66 of the trace controlling circuit 77 is designated by the trigger control signal Z2.

The collector electrode of the transistor 69 of the trace controlling circuit 77 is also connected to the wiring 102. That is, the open collector output of the transistor 69 of the trace controlling circuit 77 is also provided to the wiring 102.

As such, the two open collector outputs of the transistors 69 of the two trace controlling circuits 67 and 77 are provided to the common wiring 102 pulled up by the pull-up resistor 101. Further, the wiring 102 is connected to the trace memory controlling circuits 62 and 72. As such, a wired logic is formed, whereby the trace memory controlling circuits 62 and 72 are controlled.

Described below are details of the control of the trace memory controlling circuits 62 and 72 by the wired logic.

Described below first is the case that the trigger condition does not hold in either of or both of the trace controlling circuit 67 of the variable logic element 60 and the trace controlling circuit 77 of the variable logic element 70.

For the purpose of illustration, it is assumed that the trigger condition holds in the trace controlling circuit 67 of the variable logic element 60 but that the trigger condition does not hold in the trace controlling circuit 77 of the variable logic element 70.

In this case, the trigger condition comparing circuit 66 of the trace controlling circuit 67 provides a trigger control signal Z1 of H (high) level (a trigger control signal Z1 having the logic of “true”) to the inverter. Thus, the transistor 69 of the trace controlling circuit 67 goes off.

On the other hand, the trigger condition comparing circuit 66 of the trace controlling circuit 77 provides a trigger control signal Z2 of L (low) level (a trigger control signal Z2 having the logic of “false” which is not “true”) to the inverter. Thus, the transistor 69 of the trace controlling circuit 77 goes on.

As a result, the potential state of the wiring 102 is at L level. Similarly, in the case that the trigger condition holds in the trace controlling circuit 77 of the variable logic element 70 but that the trigger condition does not hold in the trace controlling circuit 67 of the variable logic element 60, the potential state of the wiring 102 is at L level. Further, in the case that the trigger condition does not hold both in the trace controlling circuit 77 of the variable logic element 70 and in the trace controlling circuit 67 of the variable logic element 60, the potential state of the wiring 102 is at L level.

As such, in the wired logic, when the trigger condition does not hold in either of the trace controlling circuits 67 and 77 and accordingly when the open collector outputs of the transistors 69 are at L level, the potential state of the wiring 102 is at L level, whereby the logic becomes “false” which is not “true.”

In this case, the trace memory controlling circuits 62 and 72 of the variable logic elements 60 and 70 connected to the wiring 102 do not control the start or stop of storing of the corresponding observing internal signals S-j and S-J of the under-verification sub-circuits A and B.

Described next is the case that the trigger condition holds in both of the trace controlling circuit 67 of the variable logic element 60 and the trace controlling circuit 77 of the variable logic element 70.

In this case, the trigger condition comparing circuit 66 of the trace controlling circuit 67 provides a trigger control signal Z1 of H (high) level (a trigger control signal Z1 having the logic of “true”) to the inverter. Thus, the transistor 69 of the trace controlling circuit 67 goes off.

On the other hand, the trigger condition comparing circuit 76 of the trace controlling circuit 77 provides a trigger control signal Z2 of H (high) level (a trigger control signal Z2 having the logic of “true”) to the inverter. Thus, the transistor 69 of the trace controlling circuit 77 goes off.

As a result, the potential state of the wiring 102 is at H level. As such, in the wired logic, only when the trigger condition holds in both of the trace controlling circuits 67 and 77 and accordingly when the open collector outputs of the transistors 69 in both of the trace controlling circuits 67 and 77 are at H level, the potential state of the wiring 102 is at H level, whereby the logic becomes “true.”

In this case, the trace memory controlling circuits 62 and 72 of the variable logic elements 60 and 70 connected to the wiring 102 control the start or stop of storing of the corresponding observing internal signals S-j and S-J of the under-verification sub-circuits A and B.

As such, only when the trigger condition holds in both of the trace controlling circuits 67 and 77, the potential state of the wiring 102 is at H level, whereby the logic becomes “true,” whereby instructions are issued for the start or stop of storing of the observing internal signals S-j and S-J of the under-verification sub-circuits A and B.

Thus, in the present embodiment, the effective trigger condition is a combination of the trigger conditions stored in the respective trigger condition storing circuits 65 of the trace controlling circuits 67 and 77.

In the present embodiment, the judgment of this effective trigger condition is performed by a wired logic formed in the configuration.

Accordingly, the judgment of this effective trigger condition is emulated by a very simple wiring between the variable logic elements 60 and 70.

Further, in the present embodiment, the potential of the wiring 102 for instructing the start or stop of storing of the observing internal signals S-j and S-J serves as the trigger signal.

In this point, the present embodiment is different from Embodiment 4 where the output signal of the trigger condition comparing circuit 66 is the trigger signal itself.

As described above, in the present embodiment, the trace controlling circuits 67 and 77 generate trigger control signals Z1 and Z2, for controlling the instruction of storing (the start or stop of storing) of information indicated by the observing internal signals S-j and S-J into the corresponding trace memories 61 and 71, on the basis of the trigger source signals X-i and X-I outputted from the under-verification sub-circuits A and B. In response to the trigger control signals Z1 and Z2 generated by the trace controlling circuits 67 and 77, the potential of the common wiring 102 is controlled, whereby a wired logic is formed, whereby in response to the potential of the common wiring 102, the trace memory controlling circuits 62 and 72 control the storing of the information indicated by the observing internal signals S-j and S-J into the corresponding trace memories 61 and 71.

According to this configuration, a very simple wiring 102 between the variable logic elements 60 and 70 allows the process that an instruction of storing of information indicated by the observing internal signals S-j and S-J is generated only when the logic of all the trigger control signals Z1 and Z2 from all the trace controlling circuits 67 and 77 is “true.”

That is, the judgment of the hold or the non-hold of the effective trigger condition for a plurality of variable logic elements 60 and 70 is implemented by a very simple single wiring 102 between the variable logic elements 60 and 70.

The logic emulator 5 according to the present embodiment comprises all the configurations and functions of the logic emulator 4 according to Embodiment 4. Accordingly, the logic emulator 5 according to the present embodiment also has effects similar to those of the logic emulator 4 according to Embodiment 4.

Here, the trigger control signals Z1 and Z2 generated by the trigger condition comparing circuits 66 are included within the concept of a “store instruction controlling signal” in the point that the trigger control signals Z1 and Z2 control the instruction of the storing (the start or stop of storing) of information indicated by the observing internal signals S-j and S-J.

In the above-mentioned example, the wiring 102 has been pulled up, whereby the trace memory controlling circuits 62 and 72 have been controlled by “wired AND.” However, the wiring 102 may be pulled down, whereby the trace memory controlling circuits 62 and 72 may be controlled by “wired OR.”

The variable logic elements may be composed of for example, FPGAs (Field Programmable Gate Arrays).

The number of variable logic elements is not limited to two. The present embodiment is applicable to any number of variable logic elements.

Further, the present embodiment is applicable also to the case that the connection between the variable logic elements is implemented by a dedicated variable wiring element.

In the logic emulator according to claim 1, the signal lines connected to the terminals of the second terminal group can be used by any of the predetermined plurality of variable logic units. That is, the number of signal lines available for the variable logic units is variable.

Thus, depending on the number of signal lines used by each variable logic unit determined by the result of dividing of the under-verification circuit, the signal lines are selectively used. Thus, without an increase in the variable wiring units, wastefulness and deficiency in the signal lines for each variable logic unit are suppressed as much as possible. This allows efficient use of the signal lines.

As a result, suppressed as much as possible are: a cost increase caused by the increase in the variable wiring unit; a delay in signal transmission between the variable logic units caused by excessive time division multiplex necessary due to the deficiency in the signal lines; and a decrease in operation speed of the circuit (under-verification sub-circuit) assigned to each of the variable logic units, caused by the above-mentioned delay in signal transmission.

Further, avoided is a complicated process of dividing the under-verification circuit in such a manner that the number of signal lines necessary for connection between each of the under-verification sub-circuits assigned to each of the variable logic units agrees with the number of signal lines between the variable logic units and the variable wiring unit.

As a result, suppressed as much as possible are: an increase in the process time for dividing the under-verification circuit; and wastefulness caused by the occurrence of variation in the rate of use of internal circuits among the variable logic units.

In the logic emulator according to claim 2, signal lines coming from the variable logic units and not selected by the switching unit are disconnected from the terminals of the second terminal group of the variable wiring unit.

As a result, suppressed are: signal disturbance caused by the connection of excessive signal lines; and an increase in the power consumption of the device caused by the stray capacitance of the excessive signal lines.

In the logic emulator according to claim 3, a store instructing unit for instructing the storing of information indicated by the internal signal of an under-verification sub-circuit into a corresponding memory, on the basis of source information extracted from the circuit (under-verification sub-circuit) assigned to each of the variable logic units is provided inside the variable logic units.

This allows the control of the storing of information indicated by the internal signal of an under-verification sub-circuit, without the necessity that the source information serving as the basis of instruction of the storing of information indicated by the internal signal of the under-verification sub-circuit is outputted to the outside of the variable logic units or alternatively that the instruction for the storing is inputted from the outside.

Thus, the logic emulator does not consume signal lines for the source information and the instruction of storing at the outside of the variable logic units, while the variable logic unit does not consume terminals for the output of source information and the input of instruction of the storing.

This resolves, as much as possible, deficiency in the signal lines and in the terminals of the variable logic units used in the signal transmission between the variable logic units.

The logic emulator according to claim 4 allows arbitrary setting of a condition for storing, and thereby reduces notably the occurrence of the necessity of compiling of the variable logic units and the writing of circuit data into the variable logic units at each time when the storing condition is changed.

This allows smooth and fast verification of the under-verification circuit.

In the logic emulator according to claim 5, an extremely small amount of wiring between the variable logic units allows the process that an instruction of storing is generated only when the logic of all the store instruction control signals from all the store instructing units is “true.”

The logic emulator according to claim 6 allows arbitrary setting of a condition for storing, and thereby reduces notably the occurrence of the necessity of compiling of the variable logic units and the writing of circuit data into the variable logic units at each time when the storing condition is changed.

This allows smooth and fast verification of the under-verification circuit.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A logic emulator comprising:
a plurality of variable logic units, among which an under-verification circuit is divided and assigned, and the logic emulated inside each of which can be altered from the outside; and
a variable wiring unit operable to connect a plurality of said variable logic units according to the information of a circuit to which said under-verification circuit is divided and assigned; wherein
said variable wiring unit comprises:
a plurality of first terminal groups which are provided correspondingly to a plurality of said variable logic units, and each of which comprises a plurality of terminals; and
a second terminal group which is provided correspondingly to a predetermined plurality of said variable logic units, and which comprises a plurality of terminals; and wherein:
each terminal of each of said first terminal groups is connected to a corresponding signal line wired to said corresponding variable logic unit; and
each terminal of said second terminal group is connected to a plurality of corresponding signal lines between the predetermined plurality of said variable logic units.

2. A logic emulator according to claim 1, further comprising a plurality of switching units which are provided correspondingly to the plurality of terminals of said second terminal group, and each of which is connected to a corresponding terminal of said second terminal group, wherein
each of said switching units selects a signal line from the plurality of corresponding signal lines between the predetermined plurality of said variable logic units, and then connects the signal line to the corresponding terminal of said second terminal group.

3. A logic emulator comprising:
a plurality of variable logic units, among which an under-verification circuit is divided and assigned, and the logic emulated inside each of which can be altered from the outside; and
a plurality of memories which are provided correspondingly to the plurality of said variable logic units, and each of which stores information indicated by internal signals of circuits which are under-verification sub-circuits divided from said under-verification circuit and assigned to said corresponding variable logic units; wherein
each of said variable logic units comprises:
a store instructing unit operable to instruct the storing of information indicated by said internal signal into said corresponding memory, on the basis of source information extracted from said circuit to which said under-verification circuit is divided and assigned; and
a memory controlling unit operable to control the storing of information indicated by said internal signal into a corresponding said memory, accordingly to the instruction by said store instructing unit.

4. A logic emulator according to claim 3, further comprising a condition setting unit operable to arbitrarily set a condition for the storing of information indicated by the internal signal of said circuit to which said under-verification circuit is divided and assigned, into said corresponding memory, wherein
each of said store instructing units is operable to instruct the storing of information indicated by the internal signal into said corresponding memory, according to the condition for storing, on the basis of the source information extracted from said circuit to which said under-verification circuit is divided and assigned.

5. A logic emulator according to claim 3 wherein:
each of said store instructing units is operable to generate a store instruction control signal for controlling the instruction of the storing of information indicated by said internal signal into said corresponding memory, on the basis of the source information extracted from said circuit to which said under-verification circuit is divided and assigned;
in response to the store instruction control signal generated by each of said store instructing units, the potential of a common wiring is controlled so that a wired logic is formed; and in response to the potential of the common wiring, each of said memory controlling units controls the storing of information indicated by the internal signal into said corresponding memory.

6. A logic emulator according to claim 5, further comprising a condition setting unit operable to arbitrarily set a condition for storing the information indicated by the internal signal of said circuit to which said under-verification circuit is divided and assigned, into said corresponding memory, wherein
each of said store instructing units are operable to generate said store instruction control signal, according to the condition for storing, on the basis of the source information extracted from said circuit to which said under-verification circuit is divided and assigned.
